(19) United States
(12) Patent Application Publication
(10) Pub. No.: US 2014/0009479 A1
(43) Pub. Date: Jan. 9, 2014

(54) DISPLAY SYSTEM AND IMAGE DISPLAY TERMINAL DEVICE

(71) Applicant: SEIKO EPSON CORPORATION, Tokyo (JP)

(72) Inventor: Hirokazu ISHIDA, Fujimi-machi (JP)

(73) Assignee: SEIKO EPSON CORPORATION, Tokyo (JP)

(21) Appl. No.: 13/935,831

(22) Filed: Jul. 5, 2013

(30) Foreign Application Priority Data
Jul. 9, 2012 (JP) 2012-153818
Apr. 25, 2013 (JP) 2013-092063

(51) Int. Cl. G06T 1/60

(52) U.S. Cl. CPC G06T 1/60
USPC 345/531

(57) ABSTRACT

An information processing device includes a first storage section and a first file management section. An image display terminal includes a display section, a second storage section, and a second management section, and displays information of a file transferred from the information processing device. A pdf file including first display data is stored in the first storage section, and an mcdp file including second display data in bitmap format that is matched to the attribute of the display section is generated from the first display data by the first file management section. The mcdp file is transferred to the image display terminal device together with the pdf file, and stored in the second storage section. Display of file information at the display section is controlled by the second file management section. The file information used for display is the second display data.

The entire disclosures of Japan Patent Application No. 2012-153818, filed Jul. 9, 2012 and No. 2013-92063, filed Apr. 25, 2013 are expressly incorporated by reference herein.

### BACKGROUND

1. Technical Field

Several aspects of the present invention relates to display systems, image display terminal devices, and information processing devices.

2. Related Art

The demand for electronic paper with advantages, such as, being excellent in visibility and low in electric power consumption, has been increasing in recent years, and they are used in electronic book readers (e-book readers), electronic signboards (digital signage), portable telephones in part, and the like.

In particular, electronic books have become remarkably popular, and the lifestyle in which electronic books are downloaded to and read on a portable image display terminal device is being established. Electronic paper is excellent in the visibility and low in power consumption, compared with other display media such as LCD (Liquid Crystal Display) and the like. Though electronic paper is suitable for the use in reading with a portable image display terminal device, it entails a problem, that is, its display speed is relatively slow, compared with other devices such as LCD.

To address such a problem, for example, JP-A-2012-42528 (Patent Document 1) proposes an electronic book device that can perform page turning at high speed, by dividing the screen area and displaying only partial areas with a high degree of importance, thereby displaying only a significant portion.

However, because the technique of Patent Document 1 partially abstracts the content of the screen, it cannot necessarily be satisfactory to the users.

On the other hand, in recent years, high-speed display is becoming possible through improvement of the architecture of the display controller of electronic paper, and there is a possibility to achieve a display speed to the extent acceptable to the users, by increasing the speed of processing in parsing (structure analysis) and rendering (image generation) of data file at an image display terminal device.

However, because the processing load is large in parsing and rendering processing, there is a problem that it is necessary to build a high performance CPU with high processing power in an image display terminal device, which pushes up the cost. In addition, because rendering is performed every time when the page is turned, there is a problem that the battery power consumption becomes greater.

### SUMMARY OF THE INVENTION

The invention has been made in view of the problems described above, and according to some aspects of embodiments of the invention, a display system, an image display terminal device and an information processing device that can increase the display speed and lower the power consumption at an image display terminal device equipped with an electronic paper can be provided.

The invention has been made to solve at least one of the problems described above, and can be realized by various embodiments and application examples to be described below.

### Application Example 1

A display system in accordance with the present application example includes: an information processing device including a first storage section and a first file management section; and an image display terminal device that includes a display section, a second storage section, and a second management section, and displays information of a file transferred from the information processing device. A first file including first display data is stored in the first storage section, and a second file including second display data in bitmap format matched to the attribute of the display section is generated from the first display data by the first file management section. The second file is transferred to the image display terminal device together with the first file, and stored in the second storage section. Display of file information at the display section is controlled by the second file management section, and the file information used for display is the second display data.

According to the display system pertaining to the present application example, because the image display terminal device only has to display the data in bitmap format included in the second file, it does not need to perform processing such as parsing and rendering of the first file. Therefore, the display speed at the image display terminal device equipped with an electronic paper is increased, and the power consumption at the image display terminal device can be reduced.

### Application Example 2

In the display system according to the present application example, the name of the first file may be used for displaying the name of the file at the image display terminal device.

According to the display system of the present application example, the second file is concealed to the user on the image display terminal device so that the image display terminal device is made to appear to be processing the first file at high speed.

### Application Example 3

In the display system in accordance with the present application example, the display section may have a function to acquire first additional information written in the display section. The first additional information written when the second display data is displayed is stored in the second storage section as data in vector format. When the first file is transferred to the information processing device, the data in vector format is also transferred, and combining of the data in vector format and the first file may be performed in the first file management section.

According to the display system of the present application example, the image display terminal device does not need to combine the first file and the data in vector format corresponding to the first additional information. Therefore, the processing load and the power consumption of the image display terminal device can be reduced.

### Application Example 4

In the display system in accordance with the present application example, the data in vector format may be annotated to the first display data as an independent object.

In the display system in accordance with the present application example, the information processing device does not combine the first display data included in the first file and the data in vector format added at the image display terminal device into one set of image data, but annotates the data in vector format to the first display data as an object independent of the first display data. Therefore, as the information processing device transfers the file annotated with the data in vector format as a new first file, together with the second file in which the first display data is converted into data in bitmap format, to the image display terminal device, deletion and modification of the data in vector format become possible at the image display terminal device.

### Application Example 5

In the display system in accordance with the present application example, the data in vector format may further include second additional information added by an operation at the display section. The “operation at the display section” may be, for example, an operation performed through a menu, and the “second additional information” may be, for example, an underline (under line), a book mark, and the like.

According to the display system pertaining to the present application example, the image display terminal device does not need to combine the first file and the data in vector format corresponding to the second additional information. Therefore, the processing load and power consumption of the image display terminal device can be reduced.

### Application Example 6

In the display system in accordance with the present application example, the data in vector format may be associated with the second display data, and stored in the second storage section as a part of the second file.

According to the display system pertaining to the present application example, the data in vector format is associated with the second display data and stored as a part of the second file, so that the image display terminal device does not need to perform a processing to combine the first display data included in the first file and the added data in vector format. Therefore, when a vector data image is added at the image display terminal device, the low processing load and the low power consumption of the image display terminal device can be maintained.

### Application Example 7

In the display system in accordance with the present application example, the second file may have incidental information, and may be identified, based on the incidental information, as to whether the data in vector format exists.

According to the display system pertaining to the present application example, the image display terminal device and the information processing device can readily identify, based on incidental information, as to whether the data in vector format exists in the second file.

### Application Example 8

In the display system in accordance with the present application example, the second display data may include data in bitmap format in plural resolutions.

According to the display system pertaining to the present application example, the second display data includes data in bitmap format in plural resolutions, such that, when an enlarged image or a reduced image at least with a certain fixed magnification is displayed, the image display terminal device uses one of the data in bitmap format in plural resolutions, and does not need to perform rendering, and therefore can speed up the display while suppressing the power consumption.

### Application Example 9

In the display system in accordance with the present application example, the image display terminal device may have predetermined model information, and the second display data may be generated based on the predetermined model information.

According to the display system pertaining to the present application example, by using the model information of the image display terminal device, the information processing device can generate second display data in resolution appropriate to the model of the image display terminal device. Accordingly, a highly versatile display system can be realized.

### Application Example 10

An image display terminal device in accordance with the present application example includes: a display section equipped with an electronic paper, an image display processing section that performs a processing to display an image at the display section, a storage section that stores a first file and a second file, and a file management section. The first file includes first display data, and the second file includes second display data. The second display data is data in bitmap format in which the first display data is converted to match to the attribute of the display section. When an operation to display the content of the first file is performed, the second display data is used to display the second file at the display section.

According to the image display terminal device pertaining to the present application example, by using the second display data that is data in bitmap format in which the first display data is converted to match to the attribute of the display section, parsing and rendering processing on the first file do not need to be performed, so that the display speed of the electronic paper is increased and the power consumption of the image display terminal device can be reduced.

### Application Example 11

An information processing device in accordance with the present application example includes: a storage section that stores a first file including first display data, and a file management section that generates a second file including second display data. The second display data is data in bitmap format generated from the first display data. When an operation to transfer to an external device is performed to the first file, the second display data is generated. File transfer to the external device is applied to the first file and the second file.

According to the information processing device pertaining to the present application example, when an operation to transfer to an external device is performed on the first file, the second display data in bitmap format is generated, and the first file and the second file including the second display data are transferred. Therefore the external device can achieve high-speed display by using the second display data.

### Application Example 12

A display system in accordance with another application example of the invention includes: an information processing device having a first file management section, and an image display terminal device having a second file management section. The first file management section displays a display image by using first display data included in first file information, and the second file management section displays the display image by using second display data included in second file information. The second file information includes the first display data and the second display data, and the second file information is generated in the first file management section, when the first file information is transferred from the information processing device to the image display terminal device.

### Application Example 13

In the display system in accordance with the other application example, the second display data may preferably be data in a format matched to the attribute of a display section of the image display terminal device.

### Application Example 14

In the display system in accordance with the other application example, the image display terminal device may preferably have a function to acquire first additional information written in the display section and add the first additional information to the second file information, and the second file management section may preferably display the display image by using the second display data and the first additional information.

### Application Example 15

In the display system in accordance with the other application example, when transferring the second file information from the image display terminal device to the information processing device, the second file management section may generate third file information containing the first display data and the first additional information, and the first file management section may manage the third file information as new first file information, and may display the display image by using the first display data and the first additional information.

### Application Example 16

In the display system in accordance with the other application example, each of the information processing device and the image display terminal device may preferably be used as an independent device.

### Application Example 17

In the display system in accordance with the other application example, the second display data may preferably be data in bitmap format, and the first additional information may preferably be data in vector format.

### Application Example 18

In the display system in accordance with the other application example, a display control section that controls the display section and the second file management section may preferably be composed as a semiconductor circuit device.

### Application Example 19

An image display terminal device in accordance with another application example of the invention includes a storage section, a display section in which information can be written, and a file management section, the storage section storing file information generated by another device, the file information including first display data and second display data, the file management section acquiring first additional information written by the user in the display section and adding the first additional information to the file information, and displaying an image at the display section by using the second display data and the first additional information, and the file management section outputting the first display data and the first additional information, when outputting the content of the file information to the other device.

### BRIEF DESCRIPTION OF THE DRAWINGS

FIG. 1 is an illustration for explanation of the outline of the configuration and processing of a display system in accordance with a first embodiment.

FIG. 2 is an illustration for explanation of the outline of the configuration and processing of the display system in accordance with the first embodiment.

FIG. 3 is an illustration for explanation of the outline of the configuration and processing of the display system in accordance with the first embodiment.

FIG. 4 is an illustration for explanation of the outline of the configuration and processing of the display system in accordance with the first embodiment.

FIG. 5 is a diagram showing an example of the hardware configuration of an information processing device in accordance with the first embodiment.

FIG. 6 is a figure showing an example of a file for high-speed display.

FIG. 7 is an external view of an image display terminal in accordance with the first embodiment.

FIG. 8 is a diagram showing an example of the hardware configuration of an information processing device in accordance with the first embodiment.

FIG. 9 is a block diagram of an electrophoretic display device in accordance with the first embodiment.

FIG. 10 is an example of the configuration of pixels of the electrophoretic display device in accordance with the first embodiment.

FIG. 11A is a figure showing an example of the configuration of a microcapsule, and FIGS. 11B and 11C are figures for explanation of the operation of the microcapsules.

FIG. 12 is a part of a flow chart of a processing responding to file operation by the information processing device.

FIG. 13 is a part of a flow chart of file conversion & transfer processing by the information processing device.

FIG. 14 is a part of a flow chart of file transfer & combining processing by the information processing device.

FIG. 15 is a part of a flow chart of file renaming /deletion/move/copy processing by the information processing device.

FIG. 16 is apart of a flow chart of processings by an image display terminal.

FIG. 17 is a part of a flow chart of renaming /deletion/move/copy processing by the image display terminal.

FIG. 18 is a part of a flow chart of file read & edit processing by the image display terminal.

FIG. 19 is apart of a flow chart of vector image editing processing by the image display terminal.

FIG. 20 is a diagram showing an example of a file for high-speed display in accordance with a second embodiment.

FIG. 21 is a table showing an example of model information of the image display terminal.

FIGS. 22A and 22B are illustrations showing examples of the image display terminal.

FIG. 23 is a schematic block diagram showing an example of the hardware configuration of an image display terminal in accordance with a fourth embodiment.

### DESCRIPTION OF EXEMPLARY EMBODIMENTS

Preferred embodiments of the invention are described in detail below with reference to the accompanying drawings. It is noted that the embodiments described below would not unduly limit the content of the invention recited in the scope of the patent claims. Furthermore, all of the components to be described below may not necessarily be indispensable for the invention.

### 1. First Embodiment

### 1-1. Outline of Configuration and Processing of Display System

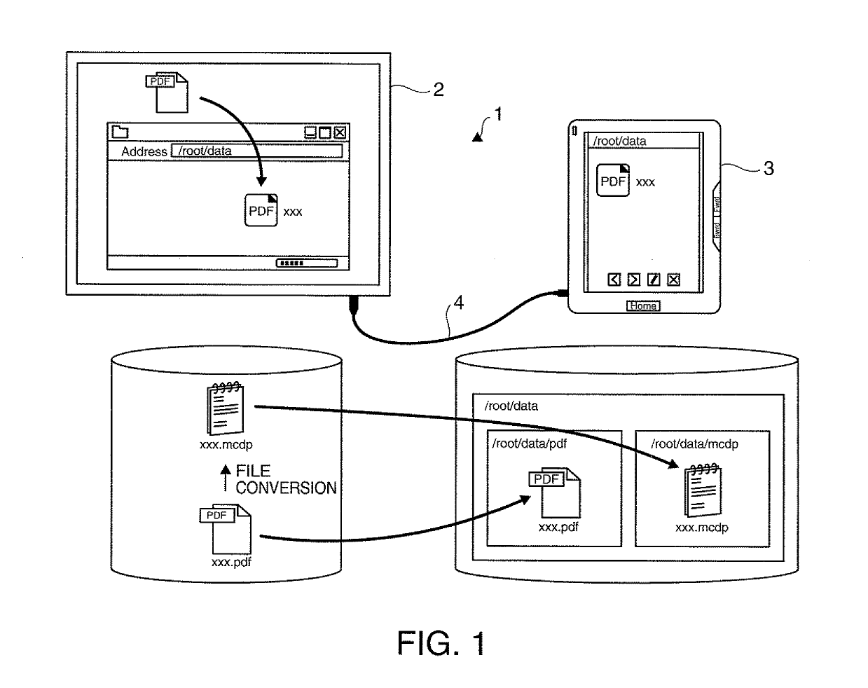

FIGS. 1-4 are illustrations for explanation of the outline of the configuration and processing of a display system in accordance with an embodiment of the invention.

The display system 1 of the embodiment includes an information processing device 2 and an image display terminal (an image display terminal device) 3. In the example shown in FIGS. 1-4, the information processing device 2 is a personal computer (PC: Personal Computer) or the like, and the image display terminal 3 is an electronic book terminal or the like. Data communication is possible between the information processing device 2 and the image display terminal 3, when connected by, for example, an USB cable 4. However, the information processing device 2 and the image display terminal 3 may perform wireless data communications.

FIG. 1 shows an operation by the user, where a folder “/root/data” of the image display terminal 3 is displayed on the display of the information processing device 2, and the user drags and drops an icon of a file xxx.pdf that exists on the screen of the information processing device 2, using the mouse (not shown) of the information processing device 2, to copy the icon of the file xxx.pdf onto the folder “/root/data” of the image display terminal 3. When this copy operation is performed, the information processing device 2 creates a file xxx.mcdp for high-speed display with the same name from the file xxx.pdf, and copies the file xxx.pdf and the file xxx.mcdp onto the image display terminal 3. At this time, the file xxx.pdf and the file xxx.mcdp are not copied onto the folder “/root/data” at the copy destination, but a folder pdf and a folder mcdp are created immediately below the folder “/root/data”, respectively, and they are separately copied onto the folder pdf and the folder mcdp, respectively. At this time, the information processing device 2 displays the pdf file copied onto the folder “/root/data/pdf” as the content of the folder “/root/data” of the image display terminal 3, but does not display the mcdp file copied onto the folder “/root/data/mcdp”. Then, the user removes the USB cable 4, and uses the image display terminal 3 as an independent unit.

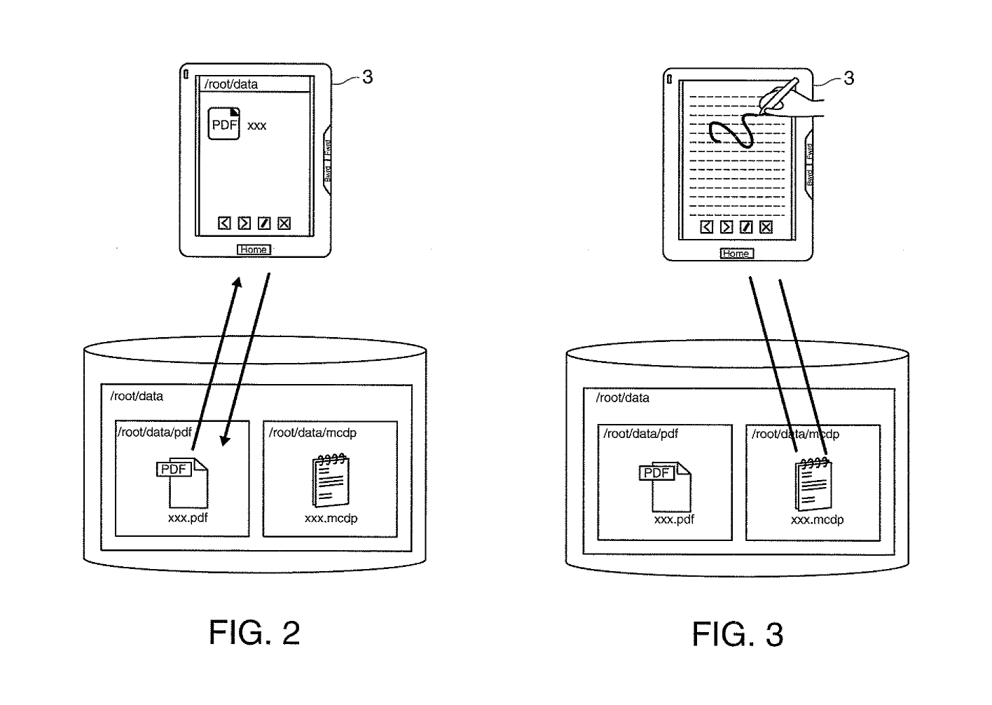

FIG. 2 shows a screen displayed on the display screen of the image display terminal 3, when the user refers to the folder “/root/data”, using the input button of the image display terminal 3. As shown in FIG. 2, though the image display terminal 3 makes the name of the folder referred being displayed as “/root/data”, it does not display the content of the folder “/root/data”, but displays the content of the folder “/root/data/pdf”. As a result, the icon of the file xxx.pdf, which does not actually exist in the folder “/root/data”, is displayed, as if it virtually exists in the folder “/root/data”. The user can perform various file operations (rename, deletion, move, copy, etc.) to the icon of this file xxx.pdf. Though the image display terminal 3 performs renaming, deletion, move, and copy of both the pdf file and the mcdp file in response to the file operation, only the pdf file is displayed on the display, and the mcdp file is not displayed. In other words, the existence of the mcdp file cannot be recognized by the user.

FIG. 3 shows a screen displayed on the display of the image display terminal 3, when the user performs a reading operation (an operation to display the content of the file) to read the file xxx.pdf that virtually exists in the folder “root/data” (but actually exists in the folder “/root/data/pdf”), using an input button of the image display terminal 3. At this time, the image display terminal 3 does not read the file xxx.pdf, but instead reads the file xxx.mcdp for high-speed display that exists in the folder “/root/data/mcdp”, and displays it on the display. The file xxx.mcdp includes image data in bitmap format suitable for the attribute (the total number of pixels, the number of display colors (gradations), etc.) of the display of the image display terminal 3 corresponding to each page of the file xxx.pdf, and therefore the image display terminal 3 does not have to process rendering, such that a high-speed display becomes possible. Moreover, the user is able to write a hand-written figure in the image displayed on the display with a touch stylus pen, and the figure, etc. written by the user are added to the file xxx.mcdp as edit data, but not to the xxx.pdf file. In other words, though the user recognizes that he or she is performing reading operation and editing operation with respect to the pdf file, but the processing is actually performed to the mcdp file.

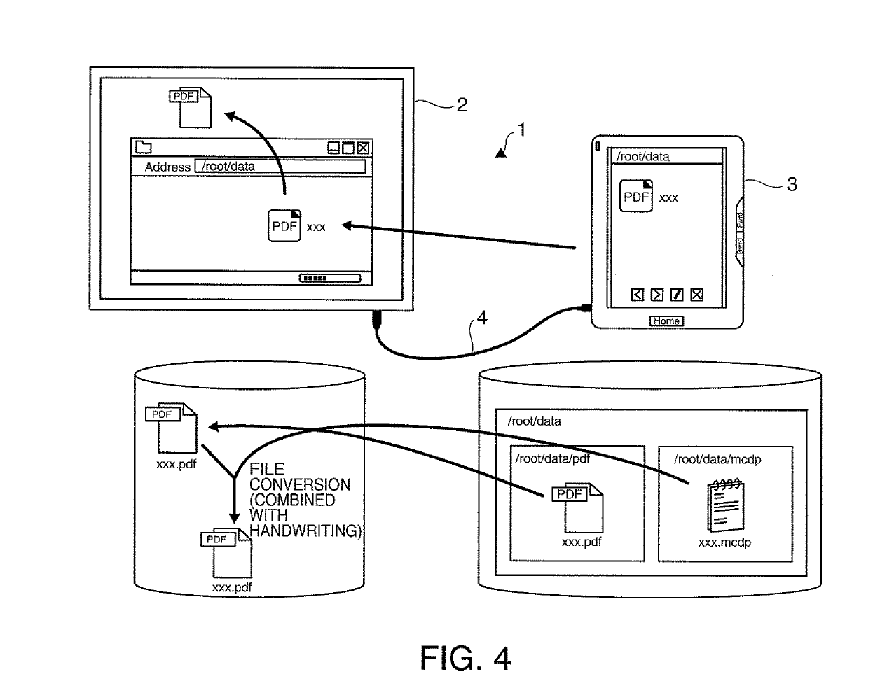

FIG. 4 shows an operation by the user, using the mouse (not shown) of the information processing device 2, where the user drags and drops an icon of a file xxx.pdf, that is displayed on the display screen of the image display terminal 3, to copy the icon onto the desktop of the information processing device 2. When this copy operation is performed, the information processing device 2 copies the file xxx.pdf that exists in the folder “/root/data/pdf” of the image display terminal 3 onto the information processing device 2. Moreover, the information processing device 2 pulls out edit data such as hand-written figures from the file xxx.mcdp that exists in the folder “/root/data/mcdp” of the image display terminal 3, and copies the data onto the information processing device 2. Then, the information processing device 2 combines the copied file xxx.pdf and the edit data, to create a new file xxx.pdf on the desktop.

### 1-2. Configuration of Information Processing Device

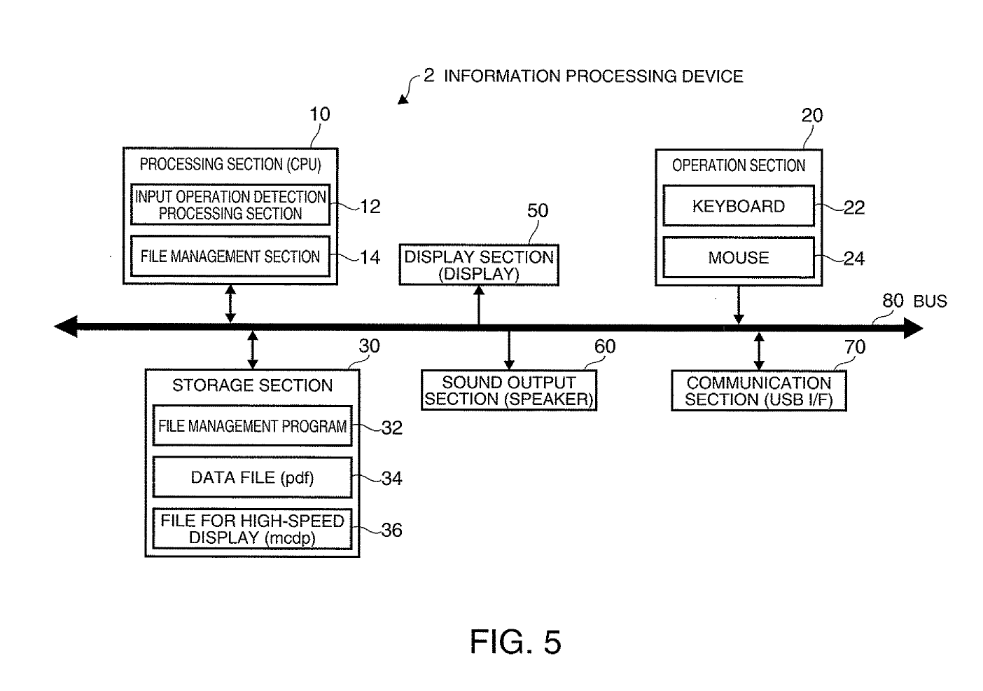

FIG. 5 is a schematic diagram of an example of the hardware configuration of the information processing device 2 in accordance with the present embodiment. The information processing device 2 of the present embodiment is composed with a processing section 10, an operation section 20, a storage section 30, a display section 50, a sound output section 60, and a communication section 70, as shown in FIG. 5. These components can mutually pass and receive various data through a bus 80. The information processing device 2 of the present embodiment may have a configuration in which a part of the components (parts) shown in FIG. 5 is omitted or changed, or other components are added.

The operation section 20 is an input device, such as, a keyboard 22, a mouse 24, or the like, outputs an operation signal corresponding to the operation by the user to the processing section 10.

The storage section 30 (an example of the first storage section) stores programs, data, etc. for various computation processing and control processing to be executed by the processing section 10. Preferably, in accordance with the present embodiment, a file management program 32 to perform processings such as displaying folders, handling files, etc. is stored (installed) in the storage section 30. Moreover, data files 34 (for example, a pdf file described in FIGS. 1-4) including display data are stored in the storage section 30. As the data file 34 including display data, files in various formats adopted as the standard for electronic books may be used besides pdf files. For example, epub (Electronic Publication) files may be used.

Moreover, the storage section 30 is used as a work area for the processing section 10. In the embodiment, a file 36 for high-speed display (for example, a mcdp file described in FIGS. 1-4) generated from the data file 34 is stored in the storage section 30.

The display section 50 is a display device (a display) composed with an LCD or the like, and displays various information based on the display signal outputted from the processing section 10.

The sound output section 60 is a device that outputs sound, such as, a speaker, and outputs various sounds (including voice sound) based on the signal outputted from the processing section 10.

The communication section 70 performs data communications with other devices by wire or wirelessly by the control of the processing section 10. For example, the communication section 70 may be a USB interface with which USB cables are connected. In this case, communications with the image display terminal 3 having a USB interface become possible through the communication section 70.

The processing section 10 performs various computation processing and control processing according to various programs stored in the storage section 30. Preferably, an input operation detection processing section 12 and a file management section 14 are included in the processing section 10 of the present embodiment. However, the processing section 10 of the embodiment may have a configuration in which a part of these compositions (elements) is omitted or changed, or other compositions (elements) are added.

The input operation detection processing section 12 performs a processing to detect an input operation by the user based on operation signals and the like from the operation section 20 (the keyboard 22 and the mouse 24).

The file management section 14 (an example of the first file management section) performs a processing according to an input operation (file operation) on a file selected from among the files displayed in the display section 50, based on the detection result of the input operation detection processing section 12.

Preferably, when a file operation, that transfers the data file 34 (an example of the first file) to the image display terminal 3, is performed, the file management section 14 in the present embodiment converts the display data (first display data) included in the data file 34 into data in bitmap format (raster format) matched to the attribute of the display section of the image display terminal 3 (second display data), thereby generating a file 36 for high-speed display including the data in bitmap format (an example of the second file), associates the data file 34 with the file 36 for high-speed display, and stores them in the storage section of the image display terminal 3. Moreover, the file management section 14 performs a processing to display the data file 34 at the display section SO, without displaying the file 36 for high-speed display as an object of the file operation.

The file management program 32 and the data file 34 may be initially stored in the storage section 30, but the processing section 10 may read the file management program 32 and the data file 34 that may be stored in a computer-readable information storage medium, and store them in the storage section 30. The computer-readable information storage medium may be, for example, an optical disk (a compact disc (CD), a digital versatile disc (DVD), a blue-ray disc (BD), a laser disc (LD) (registered trademark), etc.), a magnet-optical disk (MO), a magnetic disk (a hard disk drive (HDD), a flexible disk (FD), etc.), a magnetic tape (a digital data storage (DDS), etc.), a memory (a flash memory, a memory card, a USB memory, etc.), and the like.

Alternatively, the processing section 10 may receive the file management program 32 and the data file 34 that may be stored in an apparatus such as a personal computer (a server) through the communication section 70 and store them in the storage section 30.

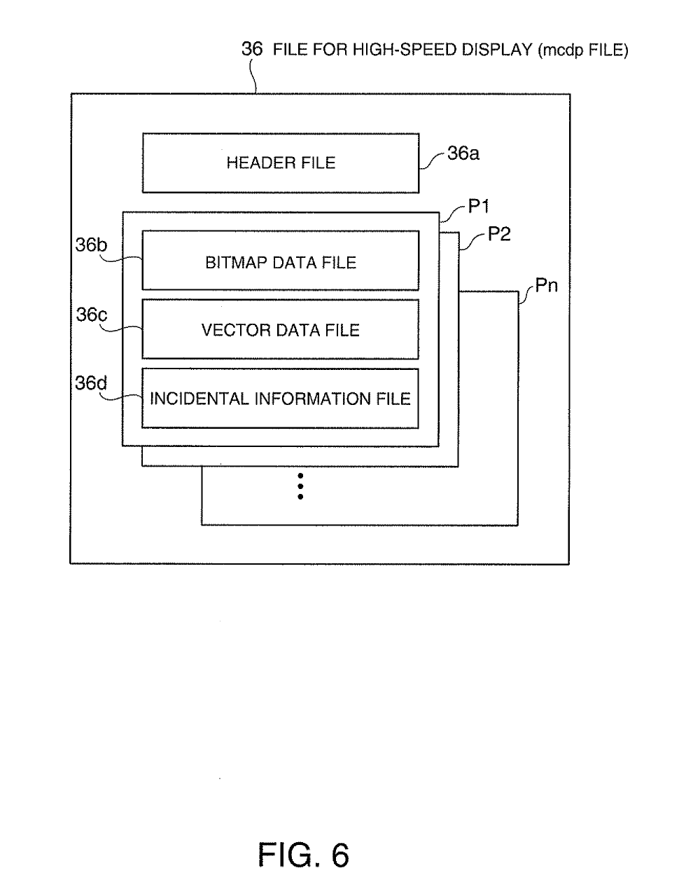

FIG. 6 is a diagram showing a configuration of the mcdp file described in FIGS. 1 to 4, which is an example of the file for high-speed display 36. In the present embodiment, the file for high-speed display (mcdp file) 36 is composed with both a header file 36a, and a bitmap data file 36b, a vector data file 36c and an incidental information file 36d for each of the pages Pk (k=1-n) for displaying the data file 34 (for example, a pdf file). In short, when the data file 34 contains display data for n pages, the file for high-speed display (mcdp file) 36 from which the data file 34 is converted includes one header file 36a, n bitmap data files 36b, n vector data files 36c and n incidental information files 36d.

Meta information such as the number of pages, the file name, etc. is included in the header file 36a.

The bitmap data file 36b (for example, a png file) includes image data in bitmap format (hereafter referred to as “bitmap data”) from which display data for one page is converted according to the attribute of the display section of the image display terminal 3.

Data of hand-written figures, characters, bookmarks, underlines, etc. (one example of the first additional information) in vector format (hereafter, “vector data”) added by the hand-writing, bookmarking, underlining functions, etc. at the image display terminal 3 are included in the vector data file 36c.

The incidental information file 36d saves incidental information. The incidental information is attribute information of each page, for example, the page number, the total number of pixels (the number of pixels in the vertical direction x the number of pixels in the horizontal direction) of the display (a display section) of the image display terminal 3, data addition flag indicative of whether added vector data is present or not (whether data exists in the vector data file 36c), etc.

The image display terminal 3 is capable of high-speed display by using the file for high-speed display (mcdp file) 36 thus configured.

### 1-3. Configuration of Image Display Terminal

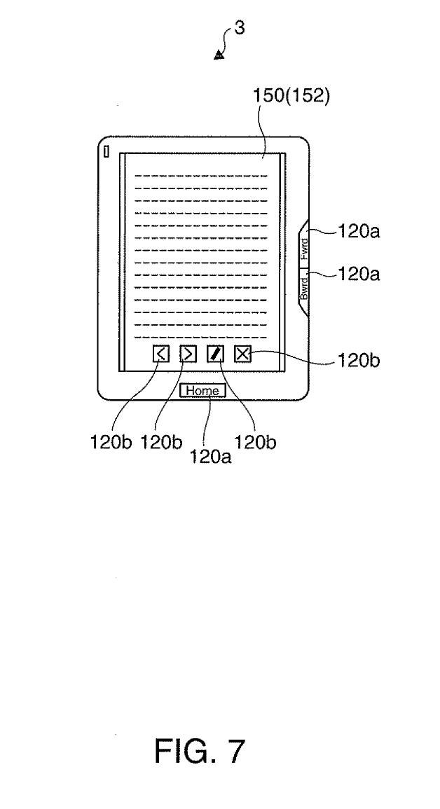

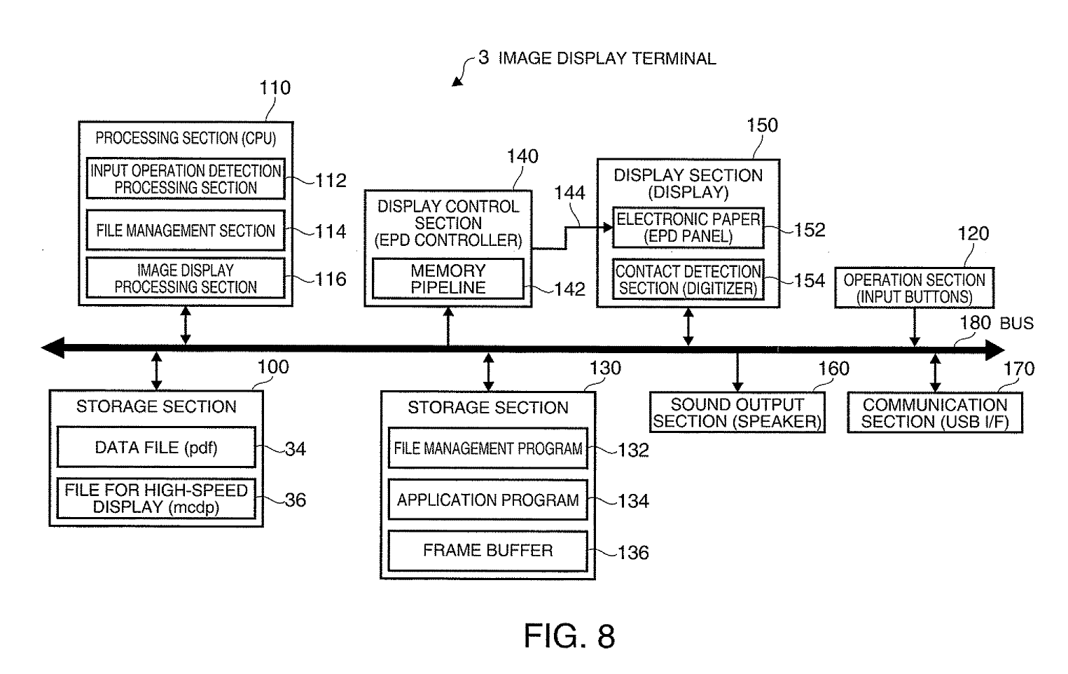

FIG. 7 is an external view of the image display terminal 3 in accordance with the present embodiment, and FIG. 8 is a diagram of an example of the hardware configuration of the image display terminal 3 in accordance with the present embodiment.

The image display terminal 3 of the present embodiment is configured with a memory section 100, a processing section 110, an operation section 120, a memory section 130, a display control section 140, a display section 150, a sound output section 160, and a communication section 170, and these components can mutually transfer and receive various data through a bus 180. The image display terminal 3 of the present embodiment may have a configuration in which a part of the components (each of the sections) in FIG. 8 is omitted or changed, or other components are added.

The operation section 120 is an input device, such as, input buttons used for input operation by the user, and may be composed of various hardware buttons 120a and various software buttons 120b (see FIG. 7), etc.

The storage section 100 (an example of the second storage section) is a storage unit, such as, a built-in NAND type flash memory or the like for saving the data file 34 transmitted from the information processing device 2 (for example, a pdf file described in FIGS. 1-4), the file for high-speed display 36 (for example, a mcdp file described in FIGS. 1-4), etc.

The storage section 130 stores programs and data for the processing part 110 to perform various computation processing and control processing. Preferably, in the present embodiment, a file management program 132 to perform processings such as displaying folders, handling files, etc. is stored (installed) in the storage section 130. Moreover, an application program 134 to read and edit the data file 34 (pdf file) by using the file for high-speed display 36 (mcdp file) is stored (installed) in the storage section 130.

Also, the storage section 130 is used as a work area for the processing section 110, and in the present embodiment, a part of the memory area is provided with a frame buffer 136 for storing bitmap data and vector data included in the file for high-speed display 36 (mcdp file), vector data, such as, figures, characters, etc. created according to the predetermined input operation by the user.

The sound output section 160 is a device that outputs sound, such as, a speaker and the like, and outputs various sounds (including voice sound) based on the signal outputted from the processing section 110.

The communication section 170 performs data communications with other devices by wire or wirelessly by the control of the processing section 110. For example, the communication section 170 may be a USB interface with which a USB cable, etc. are connected. In this case, communications with the information processing device 2 having a USB interface become possible through the communication section 170.

The display section 150 is a display device (display) equipped with an electronic paper 152, and an image corresponding to the image data stored in the frame buffer 136 is displayed on the electronic paper 152. Any one of various types of electronic paper can be used as the electronic paper 152. For example, an electrophoretic type in which charged particles are moved to switch the display, a particle rotation type in which charged particles are rotated to switch the display, a magnetophoresis type in which particles are moved with magnetism to switch the display, a display method using thin liquid crystal or electro-luminescence elements driven by a small battery, a display method using liquid crystal with memory property represented by ferroelectric liquid crystal, and the like may be suitably adopted as the electronic paper 152.

Further, the display section 150 has a contact sensing section 154 (a digitizer). The contact sensing section 154 (digitizer) may be provided opposing the screen surface of the electronic paper 152, detects the position where a stylus pen (hereafter simply referred to as a “pen”) for input or the user's finger comes in contact with the electronic paper 152, and outputs information of the contact position. For example, when the user performs an operation to input a character, a figure, etc. with the pen, or a page operation such as forward page-turning, backward page-turning, etc. by sliding the finger, the contact sensing section 154 (digitizer) outputs information about the contact position where these operations are performed.

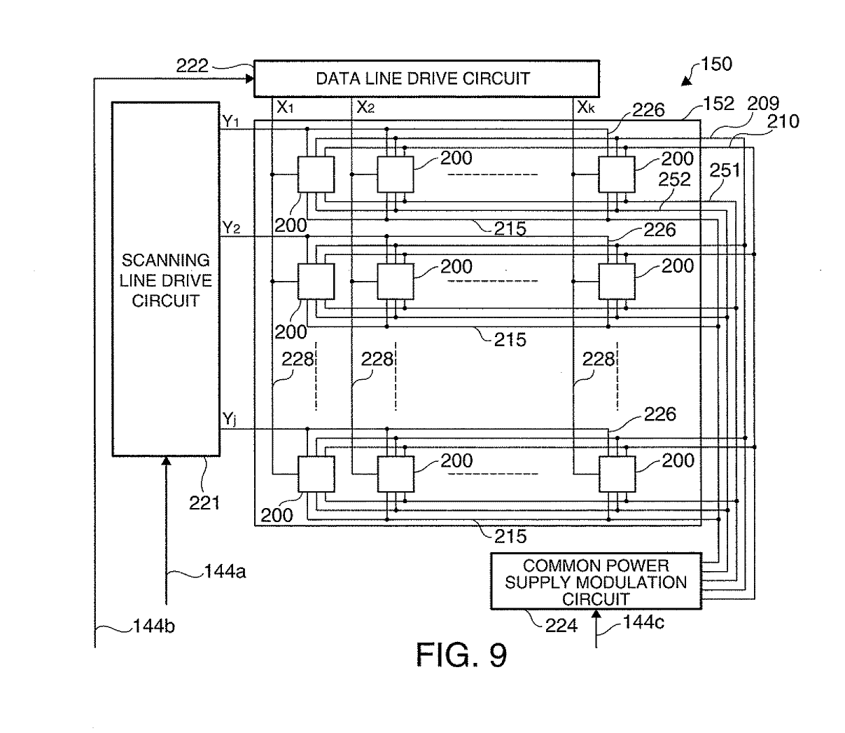

FIG. 9 is a diagram of an example of the configuration of the display section 150. The example in FIG. 9 is an active matrix type electrophoretic display device (EPD: Electrophoretic Display), and is provided with an EPD panel as the electronic paper 152. Note that, in FIG. 9, illustration of the contact sensing section 154 (digitizer) is omitted.

As shown in FIG. 9, the display section 150 includes an electronic paper 152 (an EPD panel), a scanning line drive circuit 221, a data line drive circuit 222, and a common power supply modulation circuit 224.

The scanning line drive circuit 221, the data line drive circuit 222 and the common power supply modulation circuit 224 are connected with the display control section 140 (an EPD controller) (not shown in FIG. 9), respectively, and are supplied with a control signal 144a, a control signal 144b, and a control signal 144c, that are part of the control signal 144 generated by the display control section 140, respectively.

In the electronic paper 152 (EPD panel), a plurality of scanning lines 226 extending from the scanning line drive circuit 221 and a plurality of data lines 228 extending from the data line drive circuit 222 are formed, and a plurality of pixels 200 are provided at positions corresponding to their intersections.

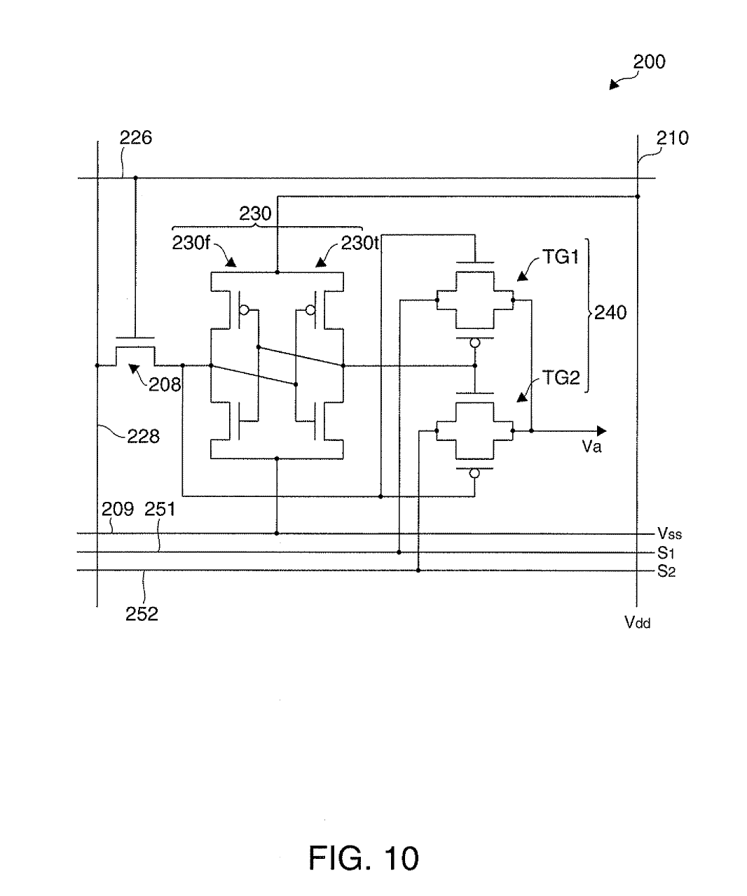

The scanning line drive circuit 221 is connected with each of the pixels 200 by j scanning lines 226 (Y1, Y2, . . . , Yj). The scanning line drive circuit 221 supplies a selection signal that defines the on-timing of driver TFTs (Thin Film Transistor) 208 (see FIG. 10) provided in the pixels 200 by sequentially selecting the scanning lines 226 from the 1^{st} line to the j^{-th} line according to the control signal 144a.

The data line drive circuit 222 is connected with each of the pixels 200 by k data lines 228 (x1, x2, . . . , Xk). The data line drive circuit 222 supplies a 1-bit image signal to each of the pixels 200 according to the control signal 144b based on the data transferred, respectively. In the present embodiment, an image signal at low level is supplied to the pixel 200 when defining pixel data “0” and an image signal at high level is supplied to the pixel 200 when defining pixel data “1”.

The electronic paper 152 (EPD panel) is also provided with low potential power supply lines 209 (Vss), high potential power supply lines 210 (Vdd), common electrode wirings 215 (Vcom), first pulse signal lines 252 (S2), and second pulse signal lines 251 (S1) extending from the common power supply modulation circuit 224. Each of the wirings is connected with the pixels 200. The common power supply modulation circuit 224 generates various signals to be supplied respectively to the above-described wirings according to the control signal 144c, while performing electrical connection and disconnection (setting high impedance, Hi-Z) of each of the wirings.

FIG. 10 is a circuit diagram of the pixels 200 shown in FIG. 9. In FIG. 10, the same reference numbers are appended with the same wirings as those shown in FIG. 9, and their description is omitted. Further, in FIG. 10, illustration of the common electrode wirings 215 common to all of the pixels is omitted.

As shown in FIG. 10, the pixel 200 is provided with a drive TFT 208, a latch circuit 230, and a switching circuit 240. The pixel 200 is configured with an SRAM (Static Random Access Memory) system that retains an image signal as a potential with a latch circuit 230.

The drive TFT 208 is a pixel switching device composed of an N-MOS transistor. The drive TFT 208 has a gate terminal connected with the scanning line 226, a source terminal connected with the data line 228, and a drain terminal connected with the data input terminal of the latch circuit 230. The latch circuit 230 has a transfer inverter 230t and a feedback inverter 230f. Power supply voltage is supplied from the low potential power supply line 209 (Vss) and the high potential power supply line 210 (Vdd) to the inverters 230t and 230f.

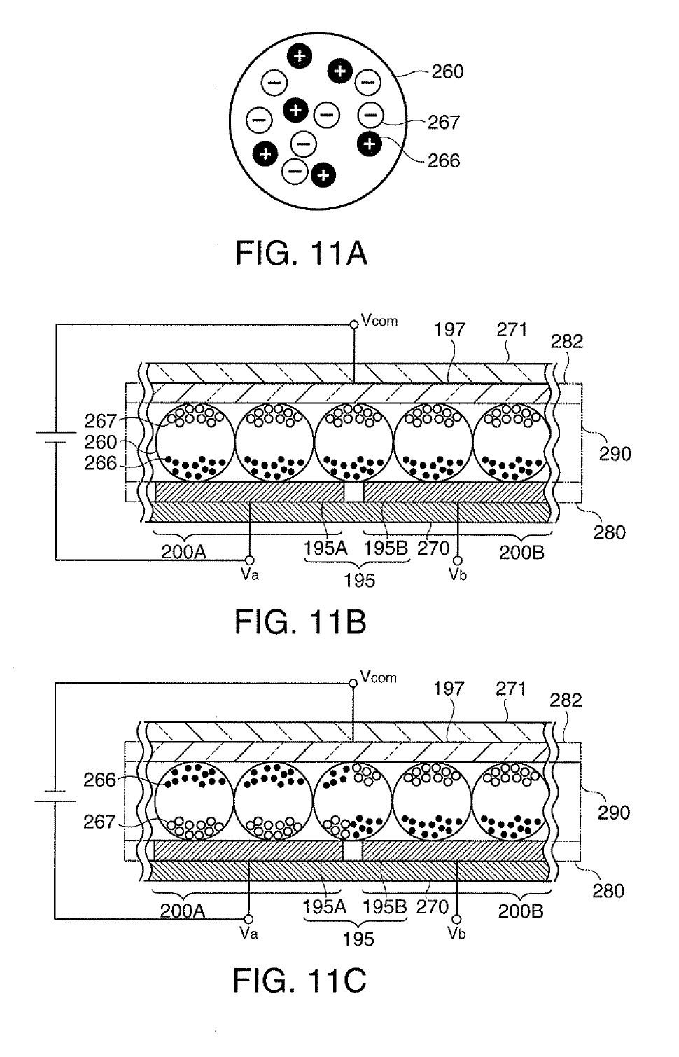

The switching circuit 240 consists of transmission gates TG1 and TG2, and outputs a signal to the pixel electrode 195 (see FIGS. 11B and 11C) according to the level of pixel data stored in the latch circuit 230. Va means a potential to be impressed to the pixel electrode of one pixel 200.

When pixel data “1” (an image signal at high level) is stored in the latch circuit 230, and the transmission gate TG1 turns on, the switching circuit 240 supplies a pulse signal S1 (a driving pulse) as Va. On the other hand, when pixel data “0” (an image signal at low level) is stored in the latch circuit 230, and the transmission gate TG2 turns on, the switching circuit 240 supplies a pulse signal S2 (a driving pulse) as Va. The potential impressed to the pixel electrode of each pixel 200 can be controlled by the control section having the circuit structure described above.

The electronic paper 152 (EPD panel) of the present embodiment may be, for example, an electrophoretic type EPD panel with two-particle type microcapsules. When the dispersion liquid is transparent and colorless, and the electrophoretic particles are white and black, at least two colors can be displayed with two colors of white and black as base colors.

FIG. 11A is an illustration showing an example of a microcapsule. The microcapsule 260 encloses, for example, transparent colorless dispersion liquid, plural white particles 267 (electrophoretic particles), and plural black particles 266 (electrophoretic particles). It is assumed that, in the present embodiment, for example, the white particles 267 are negatively charged and the black particles 266 are positively charged.

FIG. 11B is a cross-sectional view in part of the electronic paper 152 (EPD panel). The electronic paper 152 (EPD panel) includes a driving electrode layer 280 having plural pixel electrodes 195 formed on the side of the microcapsules 260 of an element substrate 270. In FIG. 11B, a pixel electrode 195A and a pixel electrode 195B are shown as the pixel electrodes 195. The potential can be supplied for each pixel by the pixel electrode 195 (for example, Va and Vb). Here, the pixel having the pixel electrode 195A is assumed to be a pixel 200A, and the pixel having the pixel electrode 195B is assumed to be a pixel 200B. The pixel 200A and the pixel 200B are two pixels corresponding to the pixels 200 (see FIG. 9 and FIG. 10).

On the other hand, a counter substrate 271 is a transparent substrate, and an image display is performed on the side of the counter substrate 271 in the display section. The electronic paper 152 (EPD panel) includes a common electrode layer 282 having a plane common electrode 197 formed on the side of the microcapsules 260 of the counter substrate 271. Note that the common electrode 197 is a transparent electrode. Unlike the pixel electrodes 195, the common electrode 197 is an electrode commonly shared by all of the pixels, and applies a potential Vcom,

The microcapsules 260 are arranged in the electrophoretic display layer 290 provided between the common electrode layer 282 and the driving electrode layer 280, and the electrophoretic display layer 290 defines a display area. A desired display color can be displayed at each pixel according to the potential difference between the common electrode 197 and the pixel electrode (for example, 195A and 195B).

In FIG. 11B, the common electrode side potential Vcom has a higher potential than the potential Va of the pixel electrode of the pixel 200A. At this moment, negatively charged white particles 267 are drawn to the side of the common electrode 197, and positively charged black particles 266 are drawn to the side of the pixel electrode 195A, such that the pixels 200A are visually recognized as displaying white.

In FIG. 11C, the common electrode side potential Vcom has a lower potential than the potential Va of the pixel electrode of the pixel 200A. At this time, in reverse, positively charged black particles 266 are drawn to the side of the common electrode 197, and negatively charged white particles 267 are drawn to the side of the pixel electrode 195A, such that the pixels 200A are visually recognized as displaying black. Note that the configuration in FIG. 11C is the same as the configuration in FIG. 11B, and therefore its description is omitted. Also, Vcom is described as a fixed potential in FIG. 11B and FIG. 11C, but the potentials Va, Vb and Vcom actually change with time.

Here, in the example of the pixels 200A in FIG. 11B and FIG. 11C, the state in which all white particles 267 or all black particles 266 are drawn to the common electrode side 197 (that is, the saturated state) is shown, respectively. However, it is possible not only to display the base color (white and black) by creating the saturation state, but it is also possible to display a half-tone color (light gray, dark gray, etc.) by impressing, for example, an electric field in the opposite direction for an appropriate period of time.

Referring back to FIG. 8, the display control section 140 (EPD controller) generates a control signal 144, and performs the control to display an image corresponding to the image data written in the frame buffer 136 on the electronic paper 152 (EPD panel) of the display section 150 (display). The display control section 140 (EPD controller) is provided with a memory pipeline 142 to manage the history of image data corresponding to an image displayed on the electronic paper 152 (EPD panel). The memory pipeline 142 retains history information in time series of image data (image data written in the frame buffer 136) corresponding to the image displayed on the electronic paper 152 (EPD panel). The display control section 140 (EPD controller) performs a control of generating driving pulses at optimum frequency and intervals in consideration of the display characteristic of the electronic paper 152 (EPD panel) based on characteristic information (color, brightness, etc. of each pixel) on an image to be displayed next and the history information retained in the memory pipeline 142, thereby displaying the next image on the electronic paper 152 (EPD panel).

The processing section 110 performs various computation processings and control processings according to various programs stored in the storage section 130. Preferably, in the present embodiment, the processing section 110 includes an input operation detection processing section 112, a file management section 114, and an image display processing section 116. However, the processing section 110 of the present embodiment may have a configuration in which a part of these compositions (components) may be omitted or modified, and other compositions (components) are added.

The input operation detection processing section 112 performs a processing that detects an input operation by the user based on operation signals from the operation section 120 and the contact sensing section 154 (digitizer).

The file management section 114 (one example of the second file management section) performs a processing according to an input operation (file operation) to a file selected from among files displayed in the display section 150 based on the detection result provided by the input operation detection processing section 112. Preferably, the present embodiment, the file management section 114 performs a processing to display the data file 34 as an object of file operation, without displaying the file for high-speed display 36 in the display section 150. Note that the processing section 110 may be made to function as the file management section 114 by executing the file management program 132.

The processing section 110 functions, by executing the application program 134, as the image display processing section 116. More specifically, when the image display processing section 116 writes picture data in the frame buffer 136, the display control section 140 controls the electronic paper 152 based on the picture data, and an image corresponding to the image data is displayed in the display section 150.

Preferably, in the present embodiment, the image display processing section 116 performs a processing to display an image in the display section 150, using the bitmap data included in the file for high-speed display 36, when a reading operation is performed with respect to the data file 34. More specifically, the image display processing section 116 performs a processing to write, in the frame buffer 136, image data stored in the bitmap data file 36b corresponding to a page to be displayed of the data file 34 included in the file for high-speed display 36. Also, the image display processing section 116 performs a processing of converting the vector data stored in the vector data file 36c corresponding to the page to be displayed into bitmap data, and writing the bitmap data in the frame buffer 136.

The file control program 132 and the application program 134 may be initially stored in the storage section 130. However, the processing section 110 may read out the file control program 132 and the application program 134 that may be stored in a computer-readable information storage medium, and store them in the storage section 130. Alternatively, the processing section 110 may receive the file control program 132 and the application program 134 that may be stored in a device, such as, a personal computer (server) through the communication section 170 and store them in the storage section 130.

### 1-4. Processing by Display System

The flow of each processing of the information processing device 2 and the image display terminal 3 in the display system 1 of the present embodiment will be described. In the following description to be made with reference to FIGS. 1 through 4, it is assumed that the data file 34 is a pdf file and the file for high-speed display 36 is a mcdp file.

### Processing by Information Processing Device

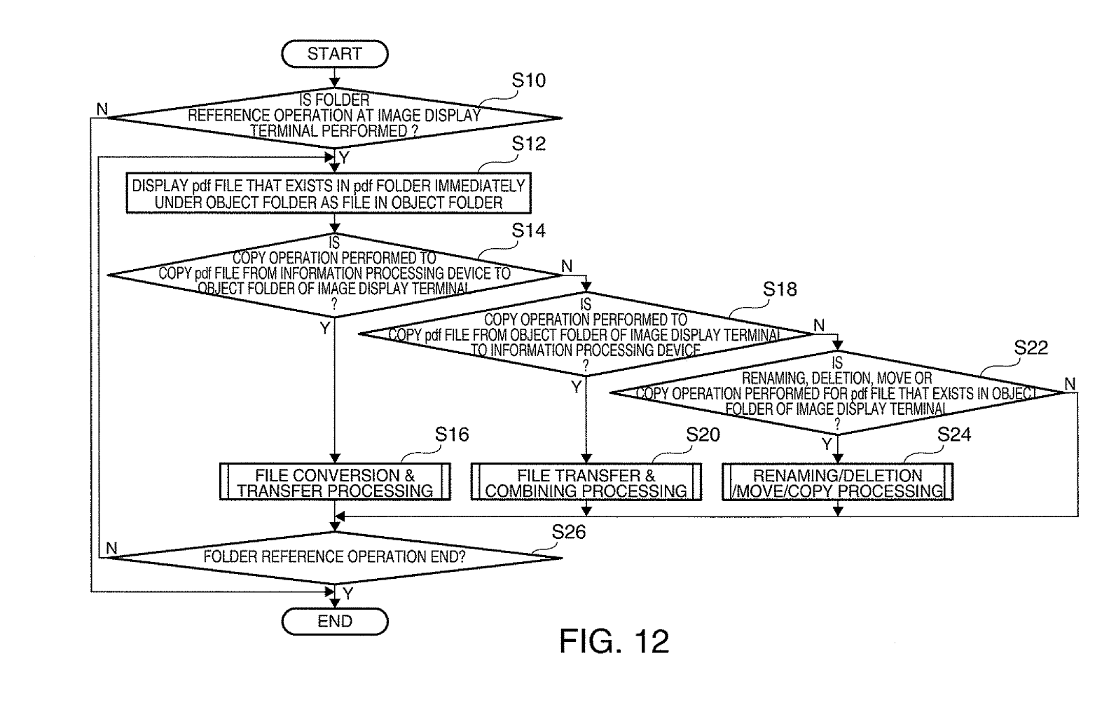

FIG. 12 is a part of a flow chart of the processing responding to file operation by the information processing device 2.

When a folder reference operation (an operation that refers to a folder) at the image display terminal 3 is performed through the operation section 20 (Y of S10), as shown in FIG. 12, the processing section 10 displays the file (xxx.pdf in FIGS. 1-4) that exists in the pdf folder (/root/data/pdf in FIGS. 1-4) immediately under the object folder (the folder selected by the folder reference operation) as a file in the object folder (/root/data in FIG. 1 or FIG. 4) (S12).

When a operation is performed to copy the pdf file from the information processing device 2 to the object folder of the image display terminal 3 (Y in S14), the processing section 10 performs a file conversion & transfer processing to be described later (S16). The file conversion & transfer processing in step S16 corresponds to the processing of the information processing device 2 executed in response to the operation shown in FIG. 1.

Also, when an operation is performed to copy the pdf file from the object folder of the image display terminal 3 to the information processing device 2 (Y of S18), the processing section 10 performs a file transfer & combining processing to be described later (S20). The file transfer & combining processing in step S20 corresponds to the processing of the information processor 2 executed in response to the operation shown in FIG. 4.

When a renaming, deletion, move or copy operation is performed for the pdf file that exists in the object folder of the image display terminal 3 (Y of S22), the processing section 10 performs a renaming/deletion/move/copy processing to be described later (S24). Note that the aforementioned copy operation is an operation to copy a file that exists in the object folder onto another folder of the image display terminal 3, and differs from the copy operation to copy a file from the object folder to the information processing device 2 (the copy operation in step S18).

Then, the processing section 10 repeats the processings in steps S12-S24 until the folder reference operation at the image display terminal 3 ends.

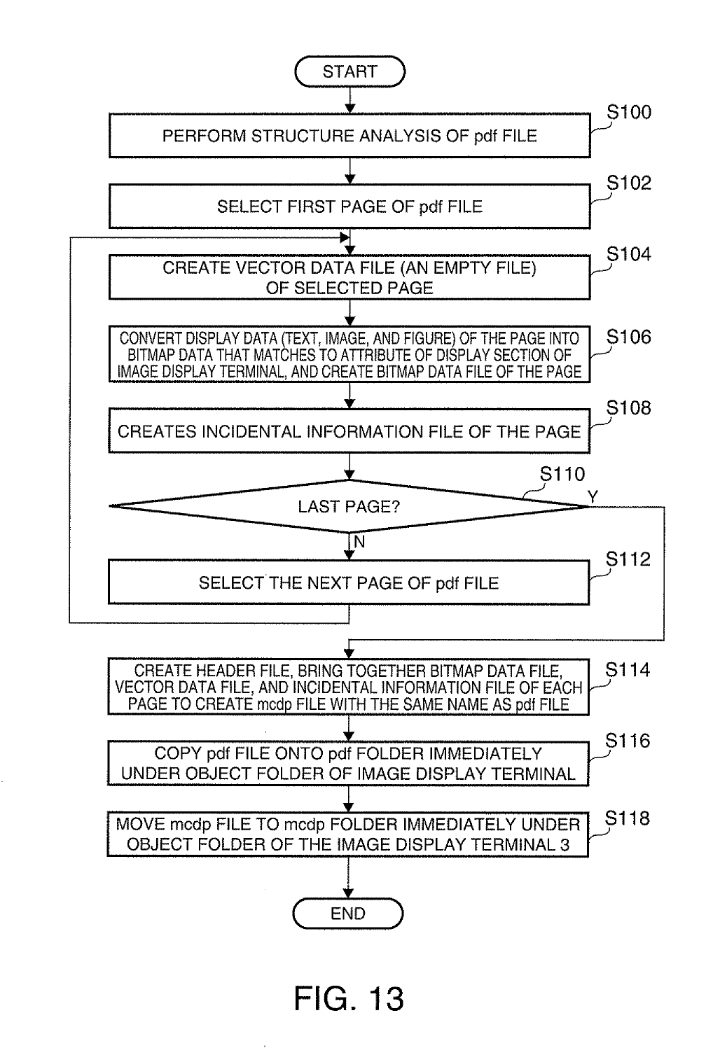

FIG. 13 is a part of the flow chart of the file conversion & transfer processing (the processing in step S16 in FIG. 12) by the processing section 10 of the information processing device 2,

First, as shown in FIG. 13, the processing section 10 performs structure analysis of the pdf file (xxx.pdf in FIG. 1) (S100).

Next, the processing section 10 selects the first page of the pdf file (S102), and creates a vector data file 36c (an empty file) of the selected page (the first page) (S104).

Then, the processing section 10 converts display data (text, image, and figure) of the page into bitmap data that matches to the attribute of the display section 150 of the image display terminal 3, and creates a bitmap data file 36b of the page concerned (S106).

Next, the processing section 10 creates an incidental information file 36d of the page concerned (S108).

If the current page is not the final page (N in S110), the processing section 10 selects the next page of the pdf file (S112), and the processings in steps S104-S110 are performed again.

On the other hand, if the page concerned is the final page (Y of S110), the processing section 10 creates a header file 36a, brings together the bitmap data file 36b, the vector data file 36c, and the incidental information file 36d of each page to create a mcdp file (xxx.mcdp in FIG. 1) with the same name as the pdf file (S114).

Next, the processing section 10 copies the pdf file (xxx.pdf in FIG. 1) onto the pdf folder (/root/data/pdf in FIG. 1) immediately under the object folder of the image display terminal 3 (S116).

Finally, the processing section 10 moves the mcdp file created in step S114 to the mcdp folder (/root/data/mcdp in FIG. 1) immediately under the object folder of the image display terminal 3, and ends the processing (S118).

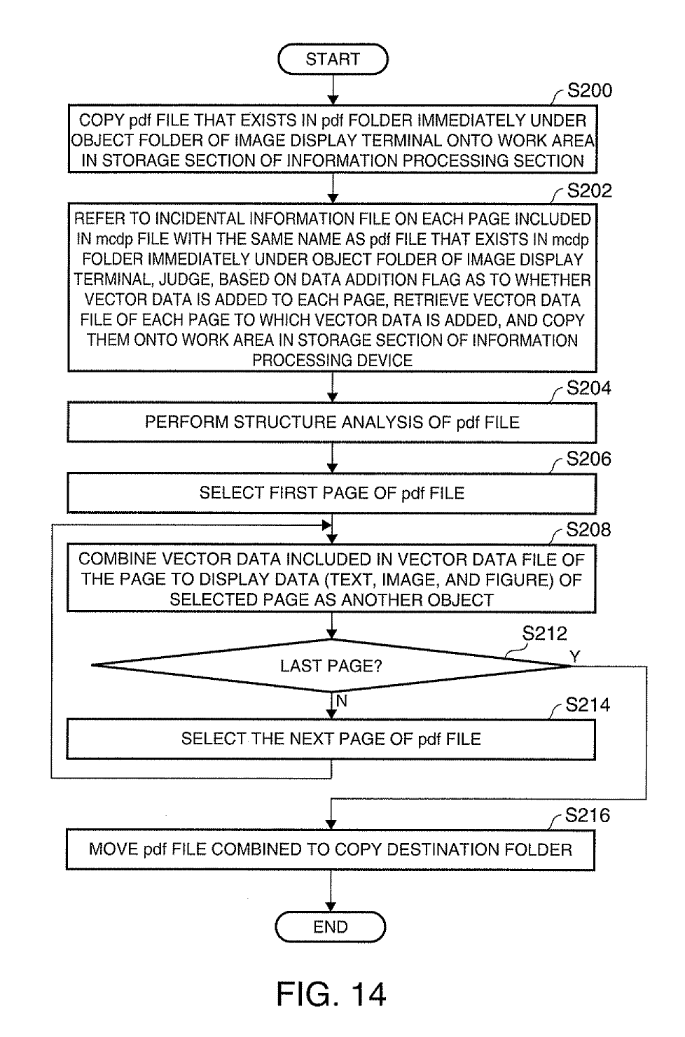

FIG. 14 is a part of the flow chart of the file transfer and combining processing (processing in step S20 in FIG. 12) executed by the processing section 10 of the information processing device 2.

First, as shown in FIG. 14, the processing part 10 copies the pdf file (xxx.pdf in FIG. 4) that exists in the pdf folder (/root/data/pdf in FIG. 4) immediately under the object folder of the image display terminal 3 onto the work area in the storage section 30 of the information processing device 2 (S200).

Next, the processing section 10 refers to the incidental information file 36d on each page included in the mcdp file (xxx.mcdp in FIG. 4) with the same name as the pdf file that exists in the mcdp folder (/root/data/mcdp in FIG. 4) immediately under the object folder of the image display terminal 3, judges based on the data addition flag as to whether vector data is added to each page, retrieves the vector data file 36c of each page to which the vector data is added, and copies them onto the work area in the storage section 30 of the information processing device 2 (S202).

Next, the processing section 10 performs the structure analysis of the pdf file (xxx.pdf in FIG. 4) copied in step S200 (S204).

Next, the processing section 10 selects the first page of the pdf file (S206), and combines vector data included in the vector data file 36c of the page concerned to the display data (text, image, and figure) of the selected page (the first page) as another object (for example, annotation to pdf) (S208).

The processing section 10 selects the next page of the pdf file (S214), if the selected page is not the final page (N in S212), and performs the processing in step S208 again,

On the other hand, if the selected page is the final page (Y in S212), the processing section 10 moves the pdf file combined in steps S206-214 to the copy destination folder (S216), and ends the processing.

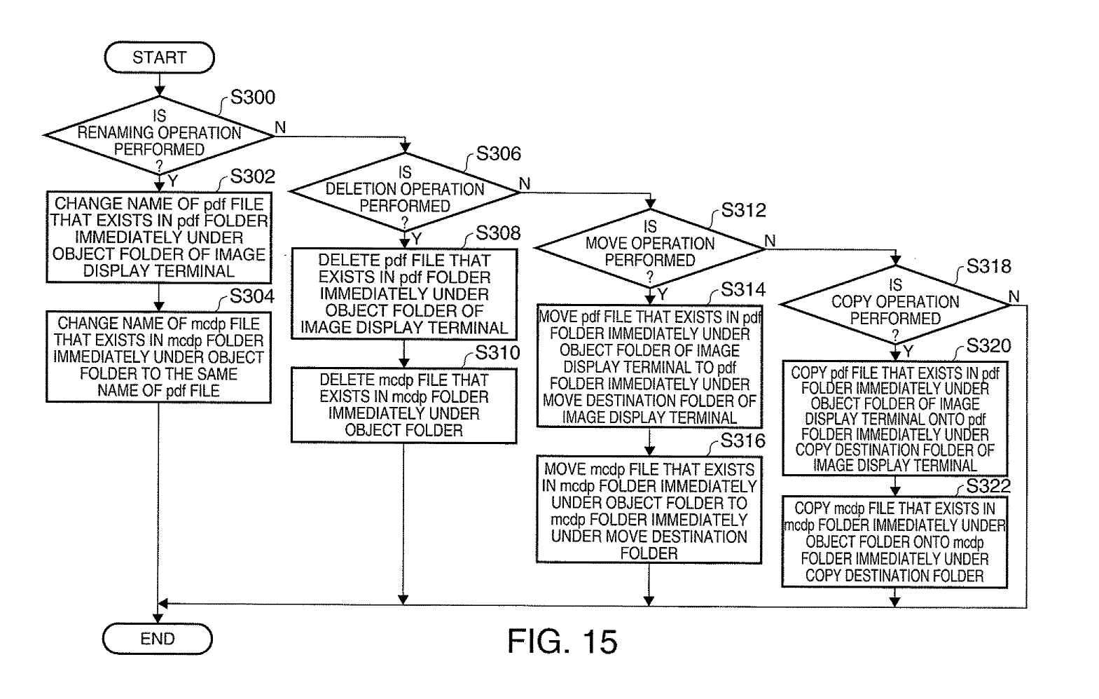

FIG. 15 is a part of the flow chart of the file renaming /deletion/move/copy processing (the processing in step S24 in FIG. 12) by the processing section 10 of the information processing device 2.

As shown in FIG. 15, when a renaming operation is performed (Y in S300), the processing section 10 changes the name of the pdf file (xxx.pdf in FIG. 1 or FIG. 4) that exists in the pdf folder (/root/data/pdf in FIG. 1 or FIG. 4) immediately under the object folder of the image display terminal 3 (for example, to yyy.pdf) (S302).

Further, the processing section 10 changes the name of the mcdp file (xxx.mcdp in FIG. 1 or FIG. 4) that exists in the mcdp folder (/root/data/mcdp in FIG. 1 or FIG. 4) immediately under the object folder to the same name (yyy.mcdp) as the pdf file (S304), and ends the processing.

Also, when an deletion operation is performed (Y in S306), the processing section 10 deletes the pdf file (xxx.pdf in FIG. 1 or FIG. 4) that exists in the pdf folder (/root/data/pdf in FIG. 1 or FIG. 4) immediately under the object folder of the image display terminal 3 (S308).

Further, the processing section 10 deletes the mcdp file (xxx.mcdp in FIG. 1 or FIG. 4) that exists in the mcdp folder (/root/data/mcdp in FIG. 1 or FIG. 4) immediately under the object folder, and ends the processing (S310).

When a move operation is performed (Y in S312), the processing section 10 moves the pdf file (xxx.pdf in FIG. 1 or FIG. 4) that exists in the pdf folder (/root/data/pdf in FIG. 1 or FIG. 4) immediately under the object folder of the image display terminal 3 to the pdf folder (/root/data1/pdf) immediately under the move destination folder (for example, /root/data1) of the image display terminal 3 (S314).

Further, the processing section 10 moves the mcdp file (xxx.mcdp in FIG. 1 or FIG. 4) that exists in the mcdp folder (/root/data/mcdp in FIG. 1 or FIG. 4) immediately under the object folder to the mcdp folder (/root/data1/mcdp) immediately under the move destination folder (/root/data1) (S316), and ends the processing.

Also, when a copy operation is performed (Y in S318), the processing section 10 copies the pdf file (xxx.pdf in FIG. 1 or FIG. 4) that exists in the pdf folder (/root/data/pdf in FIG. 1 or FIG. 4) immediately under the object folder of the image display terminal 3 onto the pdf folder (/root/data1/pdf) immediately under the copy destination folder (for example, /root/data1) of the image display terminal 3 (S320).

Further, the processing section 10 copies the mcdp file (xxx.mcdp in FIG. 1 or FIG. 4) that exists in the mcdp folder (/root/data/mcdp in FIG. 1 or FIG. 4) immediately under the object folder onto the mcdp folder (/root/data1/mcdp) immediately under the copy destination folder (/root/data1) (S322), and ends the processing.

### Processing by Image Display Terminal

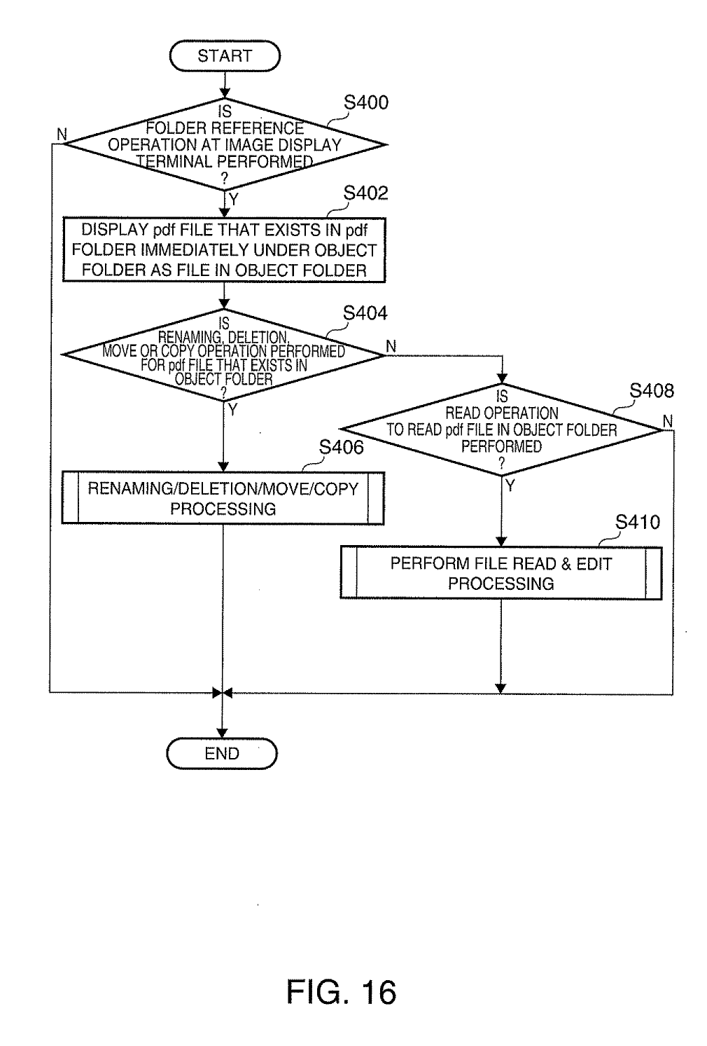

FIG. 16 is a part of the flow chart of the processing by the processing section 110 of the image display terminal 3.

As shown in FIG. 16, when a folder reference operation at the image display terminal 3 is performed (Y in S400), the processing section 110 displays the file (xxx.pdf in FIG. 2) that exists in the pdf folder (/root/data/pdf in FIG. 2) immediately under the object folder as a file in the object folder (/root/data in FIG. 2) (S402).

When a renaming, deletion, move or copy operation is performed for the pdf file that exists in the object folder (Y in S404), the processing section 110 performs a renaming/deletion/move/copy processing to be described later (S406).

Also, when a read operation to read the pdf file in the object folder is performed (Y in S408), the processing section 110 performs a file read & edit processing to be described later (S410).

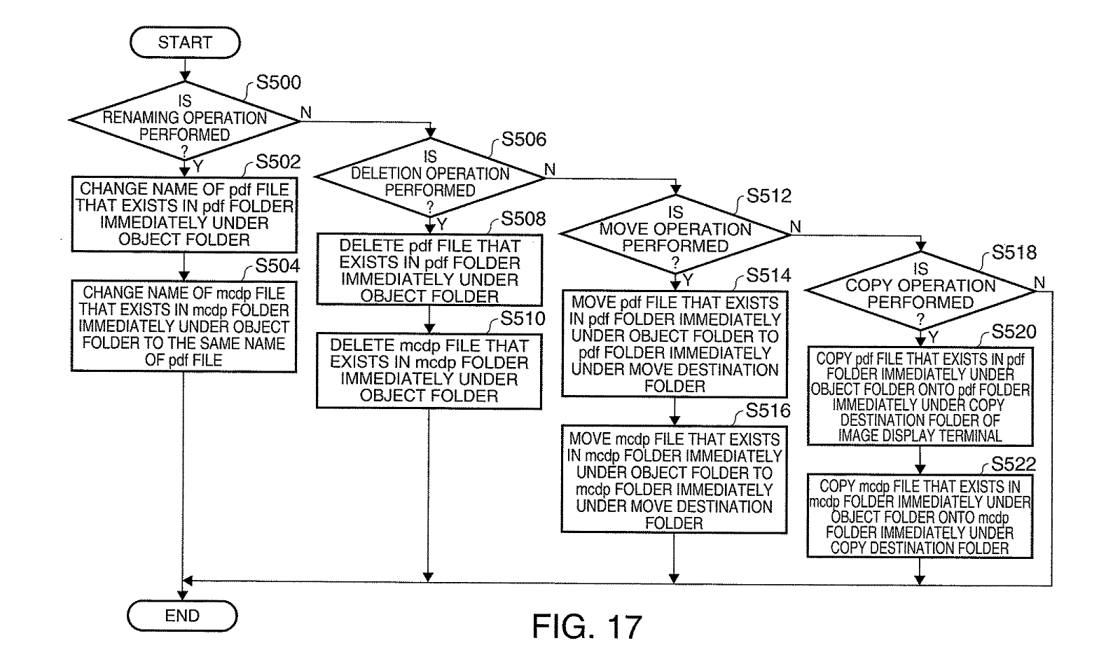

FIG. 17 is a part of the flow chart of the renaming/deletion/move/copy processing (the processing in step S406 in FIG. 16) by the processing section of the image display terminal 3.

As shown in FIG. 17, when a renaming operation is performed (Y in S500), the processing section 110 changes the name of the pdf file (xxx.pdf in FIG. 2) that exists in the pdf folder (/root/data/pdf in FIG. 2) immediately under the object folder (for example, to yyy.pdf) (S502).

Further, the processing section 110 changes the name of the mcdp file (xxx.mcdp in FIG. 2) that exists in the mcdp folder(/root/data/mcdp in FIG. 2) immediately under the object folder to the same name (yyy.mcdp) as the pdf file (S504), and ends the processing.

Also, when an deletion operation is performed (Y in S506), the processing section 110 deletes the pdf file (xxx.pdf in FIG. 2) that exists in the pdf folder (/root/data/pdf in FIG. 2) immediately under the object folder (S508).

Further, the processing section 110 deletes the mcdp file (xxx.mcdp in FIG. 2) that exists in the mcdp folder (/root/data/mcdp in FIG. 2) immediately under the object folder, and ends the processing (S510).

When a move operation is performed (Y in S512), the processing section 110 moves the pdf file (xxx.pdf in FIG. 2) that exists in the pdf folder (/root/data/pdf in FIG. 2) immediately under the object folder to the pdf folder (/root/data1/pdf) immediately under the move destination folder (for example, /root/data1) (S514).

Further, the processing section 110 moves the mcdp file (xxx.mcdp in FIG. 2) that exists in the mcdp folder (/root/data/mcdp in FIG. 2) immediately under the object folder to the mcdp folder (/root/data1/mcdp) immediately under the move destination folder (/root/data1) (S516), and ends the processing.

Also, when a copy operation is performed (Y in S518), the processing section 110 copies the pdf file (xxx.pdf in FIG. 2) that exists in the pdf folder (/root/data/pdf in FIG. 2) immediately under the object folder onto the pdf folder (/root/data1/pdf) immediately under the copy destination folder (for example, /root/data1) (S520).

Further, the processing section 110 copies the mcdp file (xxx.mcdp in FIG. 2) that exists in the mcdp folder (/root/data/mcdp in FIG. 2) immediately under the object folder onto the mcdp folder (/root/data1/mcdp) immediately under the copy destination folder (/root/data1) (S522), and ends the processing.

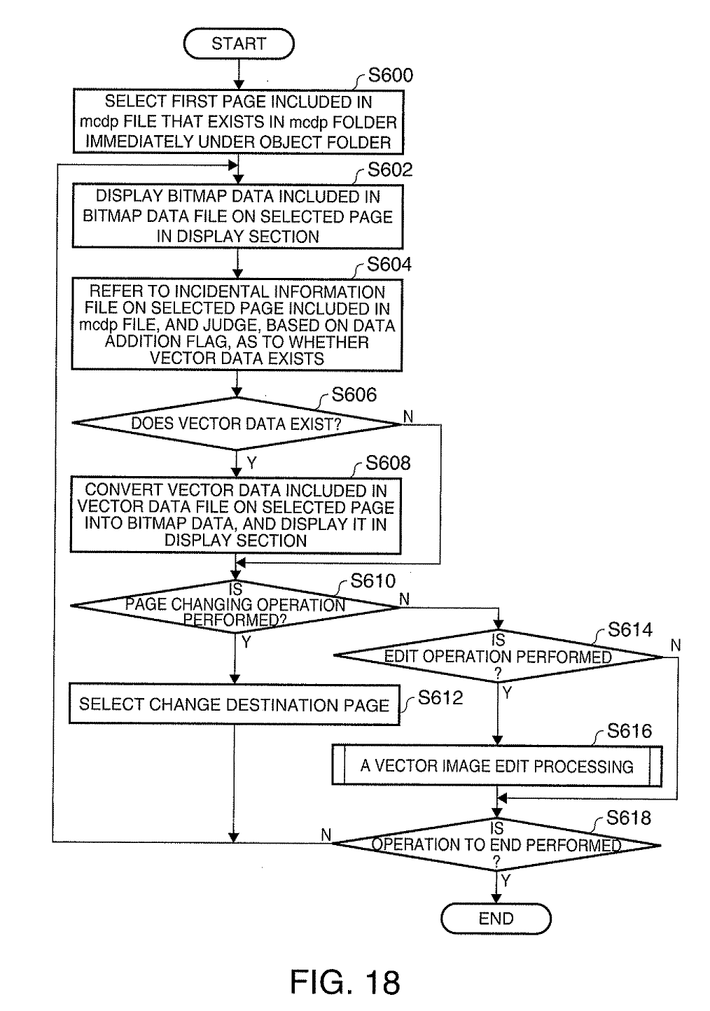

FIG. 18 is apart of the flow chart of the read & edit processing by the processing section 110 of the image display terminal 3.

As shown in FIG. 18, the processing section 110 selects the first page included in the mcdp file (xxx.mcdp of FIG. 3) that exists in the mcdp folder (/root/data/mcdp in FIG. 3) immediately under the object folder (S600), and displays bitmap data included in the bitmap data file 36b on the selected page (the first page) in the display section 150 (S602).

Next, the processing section 110 refers to the incidental information file 36d on the selected page (the first page) included in the mcdp file, and judges based on the data addition flag as to whether the vector data exists (S604).

When vector data exists in the selected page (the first page)(Y in S606), the processing section 110 converts the vector data included in the vector data file 36c on the selected page (the first page) into bitmap data, and displays it in the display section 150 (S608).

Then, when a page changing operation, such as, a forward page-turning, a backward page-turning, and a page jumping operation is performed (Y in S610), the processing section 110 selects a change destination page (S612), and performs the processings in steps S602-S608 again.

Also, when an edit operation is performed on a vector image, such as; hand-written figures, characters, bookmarks, underlines, etc. (S614), the processing section 110 performs a vector image edit processing to be described later (S616).

Then, the processing section 110 repeats the processings in steps S602-S616 until an operation to end reading is performed (N in S618). When the operation to end reading is performed, the processing that ends inspection is performed (Y in S618), the processing section 110 ends the processing.

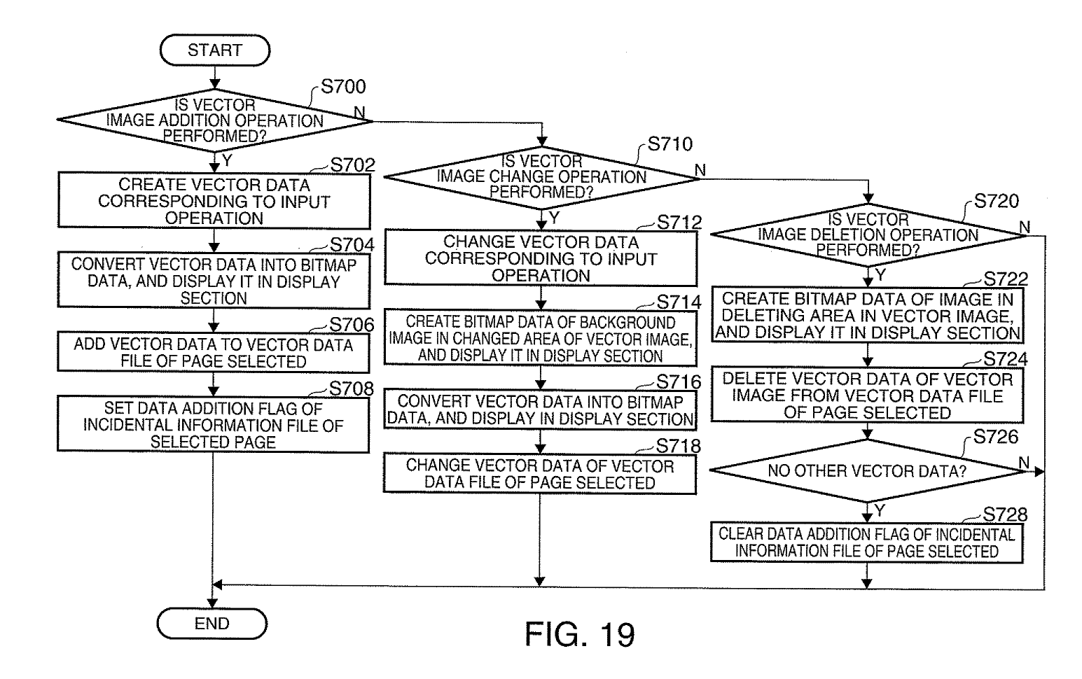

FIG. 19 is a part of the flow chart of the vector image edit processing (the processing in step S616 in FIG. 18) by the processing section 110 of the image display terminal 3.

As shown in FIG. 19, when a vector image addition operation is performed (Y in S700), first, the processing section 110 creates vector data corresponding to the input operation (addition operation) (S702).

Next, the processing section 110 converts the vector data created in step S702 into bitmap data, and displays it in the display section 150 (S704).

Next, the processing section 110 adds the vector data created in step S702 to the vector data file 36c of the page selected in step S600 or S612 in FIG. 18 (S706).

Finally, the processing section 110 sets a data addition flag of the incidental information file 36d of the selected page (S708), and ends the processing.

Further, when a vector image change operation is performed (Y in S710), first, the processing section 110 changes vector data corresponding to the input operation (change operation) (S712).

Next, the processing section 110 creates bitmap data of a background image in the changed area of the vector image, and displays it in the display section 150 (S714).

Next, the processing section 110 converts the vector data changed in step S712 into bitmap data, and displays it in the display section 150 (S716).

Finally, the processing section 110 changes (overwrites with the vector data changed in step S712) the vector data of the vector data file 36c of the page selected in step S600 or S612 in FIG. 18 (S718), and ends the processing.

Also, when a vector image deletion operation is performed (Y in S720), the processing section 110 creates bitmap data of an image in the deleting area in the vector image, and displays it in the display section 150 (S722).

Next, the processing section 110 deletes the vector data of the vector image from the vector data file 36c of the page selected in step S600 or S612 in FIG. 18 (S724).

Then, if other vector data does not exist in the vector data file 36c of the selected page (Y in S726), the processing section 110 clears the data addition flag of the incidental information file 36d of the selected page (S728), and ends the processing.

According to the display system in the first embodiment, as described above, when the operation to copy the data file 34 (pdf file) onto the folder of the image display terminal 3 is performed, the information processing device 2 renders the display data included in the data file 34 (pdf file) in a manner to match to the attribute of the display section 150 (the electronic paper 152) of the image display terminal 3, and converts it into bitmap data, thereby creating the file for high-speed display 36 (mcdp file). Therefore, because the image display terminal 3 only has to display the bitmap data included in the file for high-speed display 36 (mcdp file) when the reading operation to the data file 34 (pdf file) is performed, parsing and rendering of the data file 34 (pdf file) need not be processed. Therefore, higher display speed can be achieved even when a CPU with a low processing power is used as the processing section 110 of the image display terminal 3, and the power consumption of the image display terminal 3 can be reduced.

Moreover, according to the display system in the first embodiment, the file for high-speed display 36 (mcdp file) is concealed to the user at the information processing device 2 and the image display terminal 3, thereby making it look as if the image display terminal 3 is processing the data file 34 (pdf file) at high speed.

Moreover, according to the display system in the first embodiment, when a vector image of a hand-written character, figure, etc. is added, the image display terminal 3 only adds vector data to the vector data file 36c, and does not need to combine bitmap data included in the bitmap data file 36b with the vector data. Therefore, even when a vector image is added, low processing load and low power consumption of the image display terminal 3 can be maintained.

Moreover, according to the display system in the first embodiment, because the information processing device 2 combines vector data added by the image display terminal 3 to the data file 34 (pdf file) as an independent object (annotation to pdf), the added vector image is displayed, when the file after combined by the image display terminal 3 is read, and its deletion and change become possible.

Also, when a vector image is added, the image display terminal 3 sets a data addition flag included in the incidental information file 36d. Therefore, the information processing device 2 judges, based on the data addition flag, as to whether vector data is added to each page of the data file 34 (pdf file), and copies only truly necessary vector data from the image display terminal 3, whereby higher combining processing speed can be achieved.

Moreover, according to the display system in the first embodiment, as for the data file 34 (pdf file) and the file for high-speed display 36 (mcdp file) that are in corresponding relation, rename/delete/move/copy processings are performed on both of the files in response to file rename/delete/move/copy operations to the data file 34 (pdf file). Therefore, the information processing device 2 and the image display terminal 3 can easily manage associating the data file 34 (pdf file) and the file for high-speed display 36 (mcdp file) by the file name and the position of the folder

### 2. Second Embodiment

In the first embodiment, the file for high-speed display 36 (mcdp file) includes only one set of bitmap data file 36b, vector data file 36c, and incidental information file 36d for each page of the data file 34. In contrast, in accordance with the second embodiment, the high-speed display file 36 is initially provided with a plurality of bitmap data in different resolutions for enlargement or reduction.

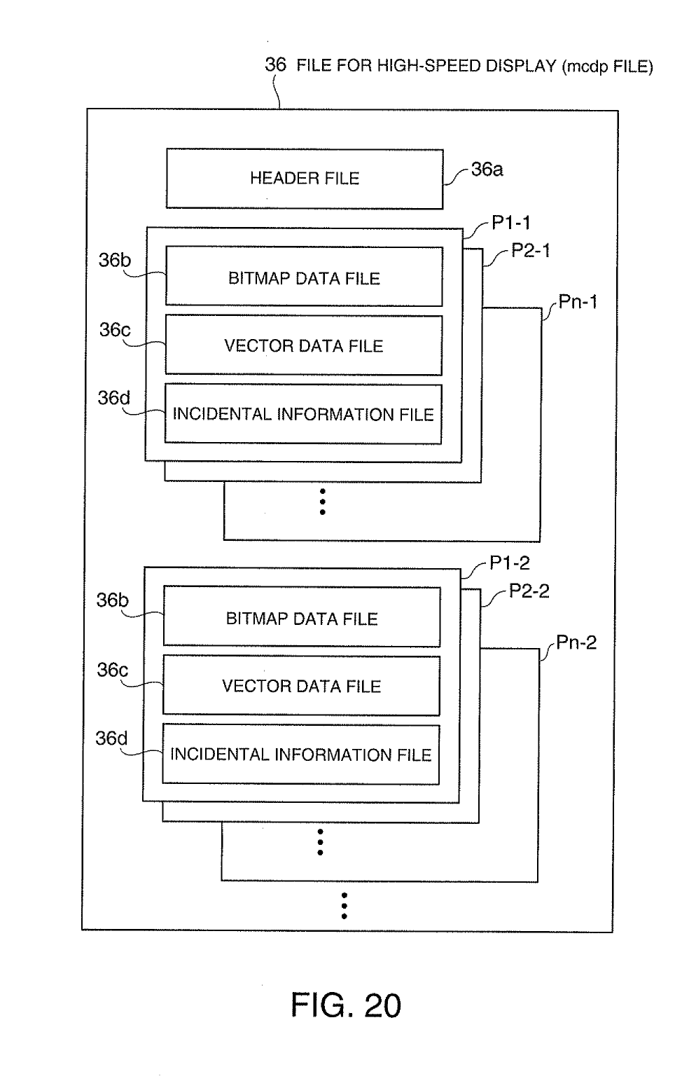

FIG. 20 is a diagram showing an example of the file for high-speed display 36 in accordance with the second embodiment. In the second embodiment, the file for high-speed display 36 (mcdp file) is composed with a header file 36a, and plural sets (the 1^{st} set Pk-1, the 2^{nd} set Pk-2, . . . ) of bitmap data file 36b, vector data file 36c and incidental information file 36d, each of the sets being provided for each page for display Pk (k=1−n) of data file 34 (for example, pdf file). The bitmap data files 36b in the respective sets Pk-1, Pk-2, . . . preserve bitmap data in resolutions mutually different from one another. The incidental information file 36d of each of the sets Pk-1, Pk-2, . . . includes information of the resolution of the bitmap data saved in the bitmap data file 36b included in the same set.

In accordance with the second embodiment, in the file conversion & transfer processing shown in FIG. 13, the processing section 10 of the information processing device 2 carries out the processing in step S102-S112 for the data file 34 multiple times, while selecting each of the predetermined multiple resolutions, thereby creating the file for high-speed display 36 (mcdp file) shown in FIG. 20 in step S114.

Moreover, in the file read & edit processing shown in FIG. 18, when an enlargement operation or a reduction operation by a predetermined magnification is performed for the displayed page, the processing section 110 of the image display terminal 3 discriminates, from the plural incidental information files 36d of the page concerned, an incidental information file 36d including information of a resolution that matches to the resolution corresponding to the enlargement operation or the expansion operation. Further, the processing section 110 writes the bitmap data included in the bitmap data file 36b in the same set as the incidental information file 36d onto the frame buffer 136, and updates the display at the display section 150. As the other compositions and processing of the display system in accordance with the second embodiment are similar to those of the first embodiment, illustration and description thereof are omitted.

According to the display system of the second embodiment, an enlarged image and a reduced image by a predetermined magnification can be displayed at high speed, while suppressing the power consumption of the battery.

### 3. Third Embodiment

In accordance with the first embodiment, bitmap data suitable for the attribute of the display section 150 (the electronic paper 152) of the image display terminal 3 is saved in the bitmap data file 36b of the file for high-speed display 36 (mcdp file). In other words, in the file conversion & transfer processing shown in FIG. 13, the processing section 10 of the information processing device 2 creates bitmap data with the total number of pixels (the number of pixels in vertical direction x the number of pixels in horizontal direction) and the number of display colors (gradations) that are pre-decided according to the model of the image display terminal 3 that is a target for the operation.

In contrast, in accordance with the third embodiment, the attribute information of the display section 150 (the electronic paper 152) is defined for each of plural models of the image display terminal 3, and based on the model information of the image display terminal 3, the processing section 10 of the information processing device 2 performs the file conversion & transfer processing on the display data of the data file 34.

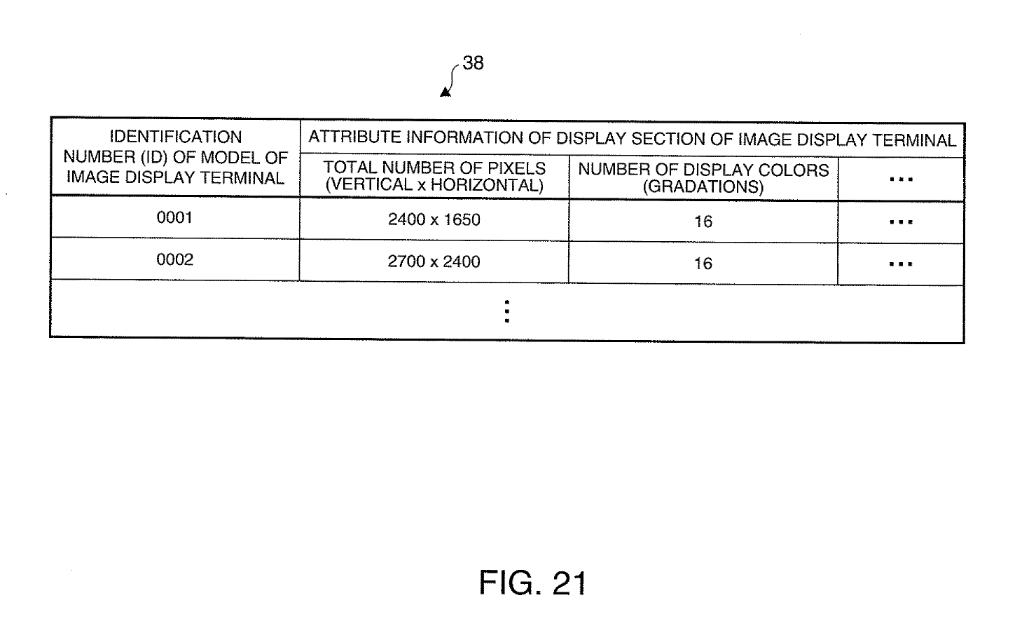

FIG. 21 is a table showing an example of the model information of the image display terminal 3. The model information 38 shown in FIG. 21 is a correspondence table that defines the relation between identification numbers (ID) of the models of the image display terminal 3 and the attribute information of the display section 150, and is stored, for example, in the memory section 30. The attribute information of the display section 150 is information of the total number of pixels (the number of pixels in longitudinal direction x the number of pixels in horizontal direction), the number of display colors (gradations), etc.

In the third embodiment, the processing section 10 of the information processing device 2 acquires identification information (ID) from the image display terminal 3 when the information processing device 2 is connected with the image display terminal 3 via the USB cable 4 or the like, for example, as shown in FIG. 1, and saves the identification information (ID) in the storage section 30. Then, in the processing in step S106 of the file conversion & transfer processing shown in FIG. 13, the processing section 10 of the information processing device 2 refers to the identification information (ID) of the image display terminal 3 and the model information 38 of the image display terminal 3 stored in the storage section 30, extracts attribute information of the display section 150 associated with the identification information (ID) from the model information 38, and converts the display data of each page of the data file 34 into bitmap data that matches to the attribute information.

The attribute information of the display section 150 may be saved in the storage section 130 or the like beforehand as the model information. For example, the image display terminal 3 may read the model information (the attribute information of the display section 150), when the information processing device 2 is connected with the image display terminal 3 via the USB cable 4, etc., as shown in FIG. 1, and may save it in the storage section 30. In this case, in the processing in step S106 of the file conversion & transfer processing shown in FIG. 13, the processing section 10 of the information processing device 2 only has to refer to the model information stored in the storage section 30 and convert the display data of each page of the data file 34 into bitmap data that matches to the model information (the attribute information). Because the other compositions and processings of the display system of the third embodiment are similar to those of the first embodiment, illustration and description thereof are omitted.

According to the display system of the third embodiment, the display data included in the data file 34 can be converted into bitmap data of an appropriate resolution corresponding to the model of the image display terminal. Therefore, a highly versatile display system can be achieved.

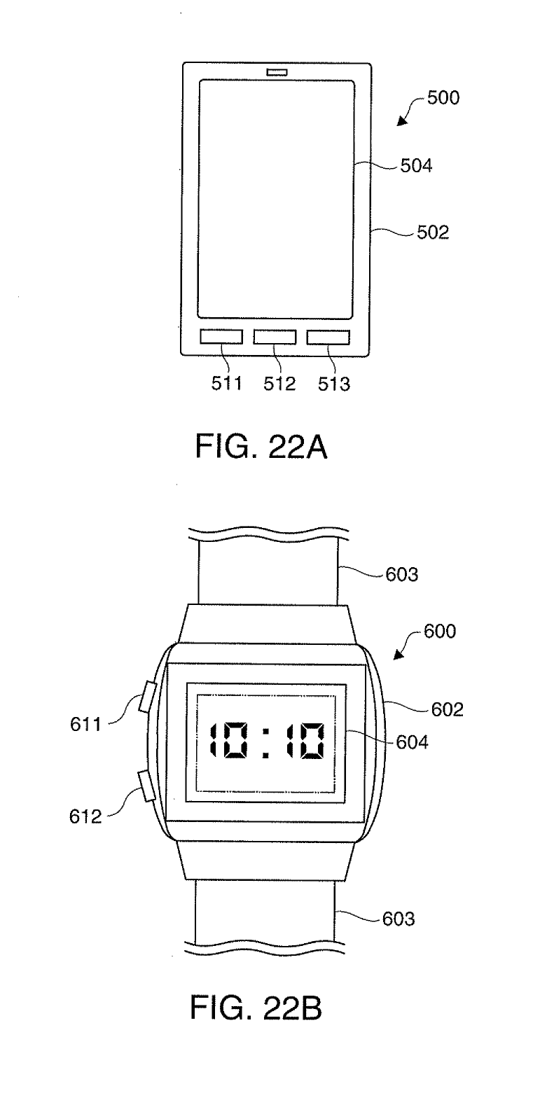

As examples other than the electronic book terminal, smart phones and wristwatches can be enumerated as the image display terminal 3, as shown in FIGS. 22A and 22B.

FIG. 22A is an external view of a smart phone 500. The smart phone 500 has a case 502. Three operating buttons 511, 512 and 513 are installed in the front face of the case 502. Also, a display section 504 that is equipped with an electronic paper, such as, an PPD panel, etc. is provided in the front face of the case 502, and various information (images) are displayed on the surface of the electronic paper. The data file 34 and the file for high-speed display 36 are stored in the built-in memory, and, the built-in CPU displays images corresponding to the operation of the pen (not shown), the operating buttons 511, 512, 513, etc. at high speed, on the surface of the electronic paper of the display section 504, using the file for high-speed display 36.

FIG. 22B is an external view of a 600. The wristwatch 600 has a case 602 and a pair of bands 603 connected to the case 602. Two operating buttons 611 and 613 are installed in the side face of the case 602. Also, a display section 604 that is equipped with an electronic paper, such as, an EPD panel, etc. is provided in the front face of the case 602, and the time and a variety of other information (images) are displayed on the surface of the electronic paper. The data file 34 and the file for high-speed display 36 are stored in a built-in memory, and a built-in CPU displays images corresponding to the operation of the pen (not shown), the operating buttons 611 and 612, etc. at high speed, on the surface of the electronic paper of the display section 604, using the file for high-speed display 36.

As the image display terminal 3 of the present embodiment, for example, an electronic signboard (digital signage), a personal computer, a cellular telephone, a digital still camera, a television set, a video camera, a videotape recorder, a car navigation device, an electronic notepad, an electronic game console, etc. can also be enumerated. The invention is not limited to the embodiments described above, and various changes can be made within the range of the subject matter of the invention,

### 4. Fourth Embodiment

In the description of the fourth embodiment, components that are the same as those of the embodiments described above will be appended with the same reference numbers, and their description will be omitted. The fourth embodiment pertains to an embodiment having an inner configuration different from that of the embodiment described above.

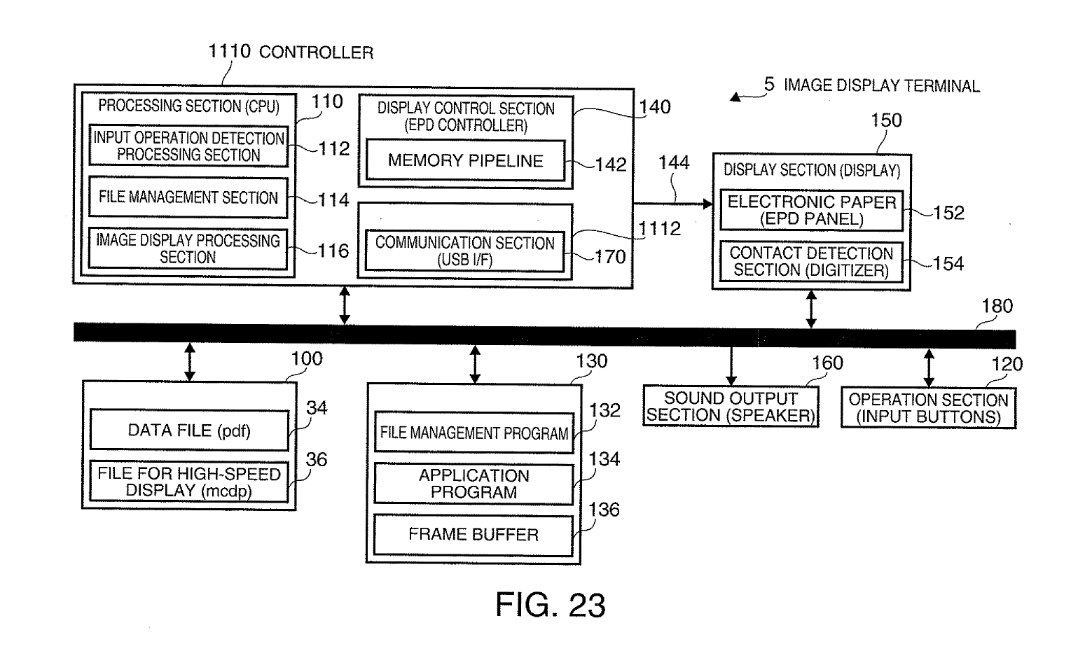

FIG. 23 shows an image display terminal 5 in accordance with the fourth embodiment. The image display terminal 5 has a controller 1110 that integrates a processing section 110, a display control section 140, and a peripheral equipment control section 1112 into one integrated circuit.

The peripheral equipment control section 1112 is, for example, a unit that controls the peripheral equipment such as the wireless LAN, etc., though not shown in the figure. The communication section 170 is included in the peripheral equipment control section 1112 in the present embodiment. Also, the information processing device in the present embodiment may be an information processing device 2 of the embodiment described above.

The display system in accordance with the present embodiment includes an information processing device having a first file management section, and an image display terminal device having a second file management section. The first file management section displays a display image by using first display data included in first file information, and the second file control section displays a display image by using second display data included in second file information. The second file information contains first display data and second display data. When the first file information is transferred from the information processing device to the image display terminal device, the second file information is generated in the first file management section.

The second display data may be data of a format matched to the attribute of the display section of the image display terminal device.

The image display terminal device may have the function to acquire first additional information written in the display section and add the same to the second file information. The second file management section may display a display image by using the second display data and the first additional information.

The second file management section may generate third file information that includes the first display data and the first additional information when transferring the second file information from the image display terminal device to the information processing device. The first file management section may manage third file information as new first file information, and may display a display image by using the first display data and the first additional information.

The information processing device and the image display terminal device may be used, respectively, as independent devices.

The second display data may be data in bitmap format, and the first additional information may be data in vector format.

The display control section that controls the display section and the second file management section may be composed as one semiconductor circuit device.

Also, the image display terminal device in the present embodiment may include a storage section, a display panel that can be written on, and a file management section. The storage section may store file information created by other devices. The file information may contain the first display data and the second display data. The file management section may acquire first additional information written in the display section by the user, and add the same to the file information. The file management section may display an image in the display section by using the second display data and the first additional information. When the content of the file information is output to other devices, the file management section may output the first display data and the first additional information.

The embodiments described above are merely examples, and the invention is not limited to these embodiments. For example, each of the embodiments may be appropriately combined with the other embodiments.

The invention may include compositions that are substantially the same as the compositions described in the embodiments (for example, a composition with the same function, method and result, or a composition with the same objects and result). Also, the invention includes compositions in which portions not essential in the compositions described in the embodiments are replaced with others. Also, the invention includes compositions that can achieve the same functions and effects or achieve the same objects of those of the compositions described in the embodiments. Furthermore, the invention includes compositions that include publicly known technology added to the compositions described in the embodiments.

What is claimed is:

1. A display system comprising:
an information processing device that includes a first storage section and a first file management section; and
an image display terminal device that includes a display section, a second storage section, and a second management section, and displays information of a file transferred from the information processing device,
the first storage section storing a first file including first display data,
the first file management section generating, from the first display data, a second file including second display data in bitmap format matched to an attribute of the display section,
the second storage section storing the second file transferred to the image display terminal device together with the first file, and
the second file management section controlling to display the file information at the display section,
the file information used for display being the second display data.

2. The display system according to claim 1, wherein the name of the first file is used as the name of the file when displayed at the image display terminal device.

3. The display system according to claim 1, wherein the display section has a function to acquire first additional information written in the display section,
the first additional information that is written when the second display data is displayed is stored in the second storage section as data in vector format,
when the first file is transferred to the information processing device, the data in vector format is also transferred to the information processing device, and
the first file management section combines the data in vector format and the first file.

4. The display system according to claim 1, wherein the data in vector format is annotated to the first display data as an independent object.

5. The display system according to claim 4, wherein the data in vector format includes second additional information added by an operation at the display section.

6. The display system according to claim 5, wherein the data in vector format is associated with the second display data, and stored in the second storage section as a part of the second file.

7. In the display system according to claim 6, wherein the second file has incidental information, the incidental information enabling identification as to whether the data in vector format is present in the second file.

8. In the display system according to claim 7, wherein the second display data includes data in bitmap format in plural resolutions.

9. The display system according to claim 8, wherein the image display terminal device has predetermined model information, and the second display data is generated based on the predetermined model information.

10. A display system comprising:
an information processing device having a first file management section; and
an image display terminal device having a second file management section,
the first file management section displaying a display image by using first display data included in first file information,
the second file management section displaying the display image by using second display data included in second file information, the second file information including the first display data and the second display data,
the second file information being generated in the first file management section, when the first file information is transferred from the information processing device to the image display terminal device.

11. The display system according to claim 10, wherein the second display data is data in format matched to the attribute of a display section of the image display terminal device.

12. The display system according to claim 11, wherein the image display terminal device has a function to acquire first additional information written in the display section and add the first additional information to the second file information, and
the second file management section displays the display image, using the second display data and the first additional information.

13. The display system according to claim 12, wherein the second file management section generates third file information containing the first display data and the first additional information, when transferring the second file information from the image display terminal device to the information processing device, and
the first file management section manages the third file information as a new set of the first file information, and displays the display image by using the first display data and the first additional information.

14. The display system according to claim 13, wherein each of the information processing device and the image display terminal device is used as an independent device.

15. The display system according to claim 14, wherein the second display data is data in bitmap format, and the first additional information is data in vector format.

16. The display system according to claim 15, wherein a display control section that controls the display section and the second file management section are integrated in a semiconductor circuit device.

17. An image display terminal device comprising:
a storage section;
a display section that is writable; and
a file management section,
the storage section storing file information generated by another device,
the file information including first display data and second display data,
the file management section acquiring first additional information written in the display section and adding the first additional information to the file information, and displaying an image at the display section by using the second display data and the first additional information, and
the file management section outputting the first display data and the first additional information, when outputting the content of the file information to the other device.
